(19) United States
(12) Patent Application Publication
(10) Pub. No.: US 2011/0047261 A1
(43) Pub. Date: Feb. 24, 2011

(54) INFORMATION COMMUNICATION APPARATUS, INFORMATION COMMUNICATION METHOD, AND PROGRAM

(75) Inventors: Kunio Gobara, Tokyo (JP); Hajime Maekawa, Osaka (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/444,883

(22) PCT Filed: Sep. 18, 2007
(86) PCT No.: PCT/JP2007/068073

§ 371 Date: Nov. 9, 2010

(30) Foreign Application Priority Data
Oct. 10, 2006 (JP) 2006-276211

(51) Int. Cl. G06F 15/173

(52) U.S. Cl. 709/224

(57) ABSTRACT

An information communication apparatus is provided which can maintain a communication by an information processing unit (for example, application program etc.) even when a change may occur in a communication with employment of an actual address.

The information communication apparatus is equipped with: an information processing unit 11 for issuing a transmission request related to communication data by employing a virtual address; an address correspondence information storage unit 12 for storing thereinto address correspondence information which corresponds to the virtual address and an actual address with each other; an address updating unit 14 for updating the address correspondence information in response to a change in the actual address detected by an actual address change detecting unit 13; a virtual communication processing unit 15 for constructing virtual communication data by employing the communication data, for acquiring an actual address corresponding to the virtual address, and for performing a communication data process operation related to the virtual communication data with employment of the acquired actual address; and also, a communication processing unit 16 for performing a communication process operation with employment of both the virtual communication data and the actual data, while the virtual communication processing unit 15 continuously performs the communication data process operation even when the change in the actual address has been detected.

### FIELD OF THE INVENTION

The present invention is related to an information communication apparatus, and the like, which are communicated with other apparatuses and the like.

### BACKGROUND ART

For instance, since line disconnections in physical layers happen to occur, there are some possibilities that communications are cut off. As the above-described line disconnections, the below-mentioned situations may be conceived: In a wireless communication, an information communication apparatus is moved outside a communicable area; an information communication apparatus is entered to a tunnel, and the like; and in a wired communication, a communication cable connected to an information communication apparatus is disconnected. Also, since a wired communication line is switched to a wireless communication line, there are some possibilities that a communication is temporarily cut off. Also, since a communication provider which is providing addresses to information communication apparatuses changes the addresses provided to these information communication apparatuses due to security aspects and other reasons, there are some possibilities that communications are temporarily cur off. In addition, in such a case that information communication apparatuses are communicated with each other via a communication apparatus having an NAT function, there are some possibilities that a port number on the WAN side of the communication apparatus having the NAT function is changed due to various sorts of reasons. Further, due to some reasons other than the above-explained reasons, the following events may occur: That is, addresses of information communication apparatuses may be changed, or communications of information communication apparatuses may be cut off.

Due to these reasons, if the below-mentioned events happen to occur, generally speaking, communications in application layers can no longer be maintained. As these events, IP addresses, port numbers, and the like may change, which have been set, otherwise, communications with employment of these set IP addresses, set port numbers, and the like may be cut off. This reason is given as follows: That is, if a communication in a lower grade layer (network interface layer etc.) is cut off, then a communication in an application layer is also cut off. As a consequence, in such a case, unless a specific condition has been set to an application program, an instruction for starting a communication in the application layer must be again issued after a communication has been again established in the lower grade layer (network interface layer etc.). For example, in such a case that a communication is cut off while a certain application program is transmitting a file to another apparatus, an instruction for retransmitting this file must be issued in the beginning.

It should be understood that as techniques capable of maintaining communications even when IP addresses are changed, the mobile IP (Internet Protocol) has been developed. In the mobile IP, even when IP addresses are changed in connection with changes in networks under connection, mobile communication terminals can be continuously communicated with a communication counter party via a home agent, a foreign agent, or the like.

Also, as relevant technical ideas, the dormant system (refer to, for instance, patent publication 1) is known in the field, which corresponds to such a communication system for releasing and re-connecting a lower grade layer under such a condition that an activated status of an upper grade session is maintained.

Patent Publication 1: JP-A-2004-135132

### DISCLOSURE OF THE INVENTION

### Problems that the Invention is to Solve

As previously explained, general-purpose application programs have such a problem that communications cannot be maintained, while these application programs cannot be properly designed for such a communication cut off event occurred in a lower grade layer such as a network interface layer when the communication is cut off in the lower grade layer such as the network interface layer. As a result, in the case that the above-described general-purpose application programs are performing communications, these general-purpose application programs are necessarily required to execute a process operation for starting a communication after the communication in the lower grade layer such as the network interface layer has been again commenced. Accordingly, extra time for performing the above-described process operation is required. Also, there is another problem that since the communication is cut off, the communication that has been so far carried out becomes useless.

Also, the mobile IP has the below-mentioned problems: That is, loads given to networks are increased; transfer delays of packets occur; loads given to home agents are increased, and so on. Moreover, since respective networks are required to be properly operable with respect to the mobile IP, there is another problem. That is, terminal apparatuses that have been connected to such a network that is not properly operable in the mobile IP cannot utilize communications based upon the mobile IP. Also, even when a mobile communication terminal is properly operable with respect to the mobile IP, if a communication in the lower grade layer such as the network interface layer is temporarily cut off, then the below-mentioned problem may occur: That is, a communication in the application layer is also cut off.

Further, in the dormant system, there is such a problem that when an address such as an IP address is changed, a communication can be no longer maintained.

The present invention has been made by solving the above-described problems, and has an object to provide an information communication apparatus, and the like, which are capable of maintaining communications of information processing units (for example, application programs etc.) even when a change may occur in communications with employment of actual addresses.

### Means for Solving the Problems

To achieve the above-described object, an information communication apparatus, according to the present invention, is featured by comprising: an information processing unit for issuing a transmission request related to communication data by employing a virtual address; an address correspondence information storage unit for storing thereinto one, or more pieces of address correspondence information which corresponds to such an information having the virtual address used in the transmission and an actual address used in the transmission in correspondence with each other; an actual address change detecting unit for detecting a change in the actual address used in the transmission; an address updating unit for updating the address correspondence information in response to the change in the actual address, which has been stored in the address correspondence information storage unit, in such a case that the actual address change detecting unit has detected the change in the actual address; a virtual communication processing unit for constructing virtual communication data by employing the communication data accepted from the information processing unit based upon the transmission request issued from the information processing unit, for acquiring an actual address from the address correspondence information, which corresponds to the virtual address accepted from the information processing unit, and for performing a communication data process operation related to the virtual communication data by employing the acquired actual address; and a communication processing unit for performing a communication process operation by accepting both the virtual communication data and the actual address from the virtual communication processing unit with employment of the accepted virtual communication data and the accepted actual address; in which even in such a case that the actual address change detecting unit has detected the change in the actual address, the virtual communication processing unit continuously performs the communication data process operation.

With employment of the above-described arrangement, even when a change occurs in a communication executed by employing an actual address, a communication executed by employing a virtual address can be maintained. As a consequence, even in such a case that the actual address has changed, the communication executed by employing the virtual address can be maintained. As a result, when a communication is restarted with employment of the actual address after having changed, the communication with employment of the virtual address can be carried out in a smooth manner without executing a process operation for starting the communication. Also, there is such a merit that the content of the communication does not become useless, which had been carried out before the actual address has changed.

Also, in the information communication apparatus according to the present invention, the communication processing unit has held an actual address of the information communication apparatus; and the actual address change detecting unit may alternatively detect a change in the actual address of the information communication apparatus.

With employment of the above-explained arrangement, the change in the actual address of the information communication apparatus can be detected.

Also, in the information communication apparatus according to the present invention, the actual address change detecting unit may alternatively detect a change in an actual address held by an apparatus of a communication destination.

With employment of the above-explained arrangement, the change in the actual address of the communication destination apparatus with respect to the information communication apparatus can be detected.

Also, in the information communication apparatus according to the present invention, the actual address change detecting unit may alternatively detect a change in an actual address defined in correspondence with specific information which corresponds to such an information for specifying the apparatus of the communication destination.

With employment of the above-explained arrangement, the apparatus of the communication destination may be exclusively specified by employing the specific information.

Also, in the information communication apparatus according to the present invention, the virtual communication processing unit may alternatively construct virtual communication data which contains the virtual address and the communication data, which are accepted from the information processing unit.

With employment of the above-explained arrangement, the virtual address can also be transmitted to the apparatus of the communication destination. It should be understood that the virtual communication data may be alternatively realized as such a packet that the communication data is contained in a payload thereof, and the virtual address is contained in a header thereof, which is similar to, for instance, a packet provided in the tunnel mode of the IPsec.

Also, in the information communication apparatus according to the present invention, the virtual communication processing unit may alternatively construct virtual communication data which contains the virtual address, but does not contain the communication data, which are accepted from the information processing unit.

With employment of the above-explained arrangement, the information which does not contain the virtual address is transmitted to the apparatus of the information destination. In this case, for example, the packet transmitted from the information communication apparatus may become such a packet provided in the transport mode of the IPsec.

Also, in the information communication apparatus according to the present invention, the information communication apparatus may be further comprised of a communication re-establishing unit for establishing a communication with employment of an actual address with respect to the communication destination in the case that the communication with employment of the actual address has been cut off.

With employment of the above-explained arrangement, the communication re-establishing unit can establish the communication with employment of the actual address with respect to the information communication apparatus and the apparatus of the communication destination thereto.

Also, in the information communication apparatus according to the present invention, the communication re-establishing unit may alternatively establish a communication with an apparatus specified by specific information that corresponds to such an information for specifying the apparatus of the communication destination which had been communicated therewith before the communication with employment of the actual address has been cut off.

With employment of the above-explained arrangement, even in such a case that the communication of the actual address established with respect to the communication destination apparatus specified based upon the specific information has been cut off, since the above-described specific information is employed, the first-mentioned communication can be again established by the communication re-establishing unit.

Also, in the information communication apparatus according to the present invention, in such a case that the actual address change detecting unit has detected a change in an actual address, the actual address change detecting unit may alternatively notify such a fact that the change in the actual address has been detected with respect to the communication processing unit.

Also, in the information communication apparatus according to the present invention, in such a case that the actual address change detecting unit has detected a change in an actual address, the actual address change detecting unit may alternatively notify such a fact that the change in the actual address has been detected with respect to the virtual communication processing unit.

### Advantage of the Invention

In accordance with the information communication apparatus and the like, even when the change may occur in the communications with employment of the actual addresses, the communications of the information processing unit can be maintained.

### BRIEF DESCRIPTION OF THE DRAWINGS

FIG. 1 is a block diagram for showing an arrangement of an information communication apparatus according to an embodiment mode 1 of the present invention.

FIG. 2 is a flow chart for describing operations of the information communication apparatus according to the present embodiment mode.

FIG. 3 is a flow chart for describing operations of the information communication apparatus according to the present embodiment mode.

FIG. 4 is a flow chart for describing operations of the information communication apparatus according to the present embodiment mode.

FIG. 5 is a diagram for explaining operations of the information communication apparatus according to the present embodiment mode.

FIG. 6 is a diagram for explaining operations of the information communication apparatus according to the present embodiment mode.

FIG. 7 is a diagram for explaining operations of the information communication apparatus according to the present embodiment mode.

FIG. 8 is a diagram for representing one example of an information system containing the information communication apparatus according to the present embodiment mode.

FIG. 9 is a diagram for indicating one example of actual addresses held in a communication establishing server according to the present embodiment mode.

FIG. 10 is a diagram for indicating one example of address correspondence information provided in the present embodiment mode.

FIG. 11 is a diagram for showing one example of virtual communication data provided in the present embodiment mode.

FIG. 12 is a diagram for indicating one example of a communication packet provided in the present embodiment mode.

FIG. 13 is a diagram for representing one example as to the address correspondence information provided in the present embodiment mode.

FIG. 14 is a diagram for showing another example as to the address correspondence information provided in the present embodiment mode.

FIG. 15 is a diagram for showing another example as to the address correspondence information provided in the present embodiment mode.

FIG. 16 is a diagram for showing another example of the virtual communication data provided in the present embodiment mode.

FIG. 17 is a block diagram for showing an arrangement of an information communication apparatus according to an embodiment mode 2 of the present invention.

### DESCRIPTION OF REFERENCE NUMERALS AND SIGNS

1, 2, 4 information communication apparatus
3 communication establishing server
11 information processing unit
12 address correspondence information storage unit
13 actual address change detecting unit
14 address updating unit
15 virtual communication processing unit
16 communication processing unit
17 communication re-establishing unit

### BEST MODE FOR CARRYING OUT THE INVENTION

A description is made of information communication apparatuses according to the present invention with employment of embodiment modes. It should be understood that structural elements and steps to which the same reference numerals have been applied are identical to, or similar to each other in the below-mentioned embodiment modes, and duplicated explanations thereof will be sometimes omitted.

### Embodiment Mode 1

Referring now to drawings, a description is made of an information communication apparatus according to an embodiment mode 1 of the present invention.

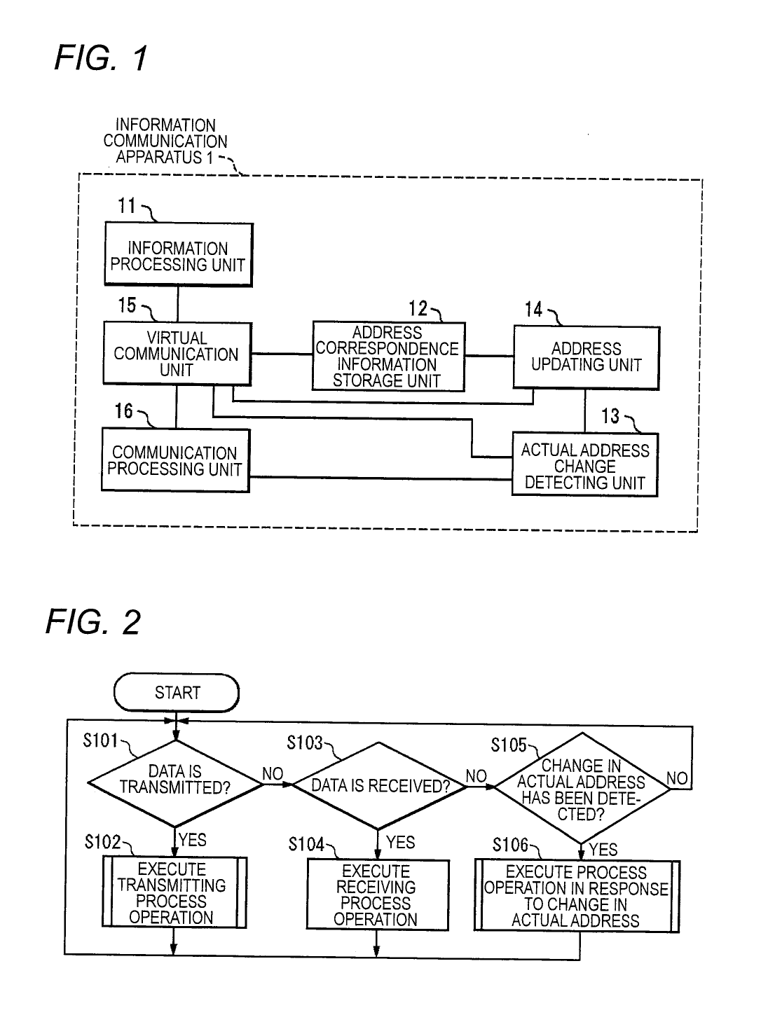

FIG. 1 is a block diagram for indicating an arrangement of an information communication apparatus 1 according to the present embodiment mode. In FIG. 1, the information communication apparatus 1 according to the present embodiment mode is equipped with an information processing unit 11, an address correspondence information storage unit 12, an actual address change detecting unit 13, an address updating unit 14, a virtual communication processing unit 15, and a communication processing unit 16.

The information processing unit 11 issues a transmission request related to communication data by employing a virtual address. More concretely speaking, the information processing unit 11 passes both the communication data corresponding to data which is wanted to be transmitted, and a virtual address corresponding to a communication destination to which this communication data is wanted to be transmitted with respect to the virtual communication processing unit 15 in order that the virtual communication processing unit 15 is required to transmit the above-described communication data to the communication destination corresponding to the virtual address. A virtual address implies such a virtual address that is different from an actual address. An actual address implies such an address that is employed in a header of a packet that is actually transmitted from the information communication apparatus 1. It should also be noted that while the information processing unit 11 is realized by, for example, a general-purpose application program and the like, this general-purpose application program and the like may alternatively issue a transmission request by regarding the virtual address as the actual address. This reason is given as follows: That is, the information processing unit 11 need not recognize a correspondence relationship between the actual address and the virtual address. Also, the above-described transmission request may be produced by a concrete command, or may be alternatively produced by judging that since the virtual address and the communication data are passed, it may be judged that the transmission request has been issued by the virtual communication processing unit 15. Alternatively, the information processing unit 11 may receive the communication data which has been transmitted to the information communication apparatus 1 from the virtual communication unit 15.

It should also be noted that the virtual address is not such an address that is fixed with respect to the information communication apparatus 1, but may be a changeable address. For instance, a virtual address which is employed in such a case that the information processing unit 11 performs a communication operation of a moving picture with respect to an apparatus “A” of a communication destination may be alternatively different from another virtual address which is employed in such a case that the information processing unit 11 performs a communication operation of voice with respect to another apparatus “B” of another communication destination.

The address correspondence information storage unit 12 stores thereinto one, or more pieces of address correspondence information which are such information having virtual addresses used in transmissions, and actual addresses used in transmissions in correspondence with each other. As previously explained, an actual address implies such an address which is actually employed in a communication established between apparatuses, for example, the information communication apparatus 1 and the like. An actual address corresponds to such an address contained in either a packet that is transmitted by the information communication apparatus 1 or a header of a packet that is received by the information communication apparatus 1. It should also be understood that an actual address and a virtual address may be any one of, for instance, IP addresses, port numbers, addresses of the IEEE 1394, and the like, otherwise may be any combination of these items. It should also be noted that the address correspondence information storage unit 12 may be realized by a predetermined recording medium (for example, semiconductor memory, magnetic disk, optical disk etc.).

The actual address change detecting unit 13 detects a change in an actual address that is used in a transmission. For instance, the actual address change detecting unit 13 may detect a change in an actual address of the information communication apparatus 1, may detect a change in an actual address which has been held by an apparatus of a communication destination with respect to the information communication apparatus 1, or may detect both the change in the actual address of the information communication apparatus 1, and the change in the actual address held by the apparatus of the communication destination. It should also be noted that a change in an actual address may imply the below-mentioned address changes: That is, for instance, an actual address may have changed from a certain address to another address; an actual address may be deleted; or an actual address may be newly set. If a change in an actual address may be finally detected as a result, then the actual address change detecting unit 13 may alternatively detect the change in the actual address by detecting an occurrence of another event, or the like. A concrete method for detecting a change in an actual address by the actual address change detecting unit 13 will be discussed later. In such a case that the actual address change detecting unit 13 detects a change in an actual address, the actual address change detecting unit 13 may notify such a message that the change in the actual address has been detected to a communication processing unit 16.

In this connection, a description is made of methods for detecting changes in actual addresses that are performed by the actual address change detecting unit 13.

(1) Detection Based Upon a Communication Error of “Keep Alive Packet”:

For example, there are some cases that a packet is transmitted in a repetition manner between the information communication apparatus 1 and an apparatus of a communication destination thereof due to such a reason that a communication path is maintained. In general, this packet is referred to as a “keep alive packet.” The above-described keep alive packet may be transmitted every time, for instance, 30 seconds have passed. The keep alive packet may be transmitted by, for example, the virtual communication processing unit 15, or by other structural elements. In such a case that the communication of this keep alive packet has not been carried out in a proper manner, the actual address change detecting unit 13 may alternatively detect that the actual address as to either the information communication apparatus 1 or the apparatus of the communication destination has changed. The above-described case that the communication of the keep alive packet has not been carried out in the proper manner corresponds to, for instance, such a case where a communication error has occurred with respect to the keep alive packet transmitted from the information communication apparatus 1; another case where such a packet that the keep alive packet transmitted from the information communication apparatus 1 is not received from the apparatus of the communication destination; a further case where the information communication apparatus 1 has not received the keep alive packet which had been transmitted in the repetition manner from the apparatus of the communication destination; and the like. For example, in such a case that the information communication apparatus 1 is located outside a communication service area of a wireless network, the keep alive packet cannot be transmitted. Since the keep alive packet cannot be transmitted, the actual address change detecting unit 13 may detect such a fact that the actual address of the information communication apparatus 1 has changed, namely this actual address could not be used. Also, for example, in such a case that an actual address of an apparatus of a communication destination with respect to the information communication apparatus 1 has changed, a keep alive packet does not reach the apparatus of the communication destination. Then, a packet of “ICMP Destination Unreachable” is resent. Since this packet of “ICMP Destination Unreachable” is received by the information communication apparatus 1, the actual address change detecting unit 13 may detect such a fact that the actual address of the apparatus of the communication destination has changed. In the present embodiment mode, the below-mentioned case will be described. That is, in this case, since the communication of the keep alive packet has not been carried out in the proper manner, the change in the actual address is detected.

It should also be understood that even when an actual address of the information communication apparatus 1 has changed, there are some cases that a keep alive packet transmitted from the information communication apparatus 1 to an apparatus of a communication destination is received in a proper manner by the apparatus of the communication destination. In such a case, the actual address change detecting unit 13 need not detect a change in the actual address. In other words, the change in the actual address detected by the actual address change detecting unit 13 may be substituted by a change in an actual address in such a case that a communication between the information communication apparatus 1 and the apparatus of the communication destination is cut off.

(2) Detection Based Upon Reception of such a Fact from an Apparatus of a Communication Destination that an Actual Address has Changed:

In such a case that an actual address as to an apparatus of a communication destination with respect to the information communication apparatus 1 has changed, the actual address change detecting unit 13 may detect such a fact that the actual address as to the apparatus of the communication destination has changed by directly receiving such a fact from the apparatus of the communication destination, or by receiving such a fact via a server, or the like from the apparatus of the communication destination. Also, there are some cases that although the actual address of the information communication apparatus 1 has already changed, a packet transmitted by the information communication apparatus 1 may be received by the apparatus of the communication destination. For instance, as the above-described case, there is such a case that an NAT, or the like is not present between the information communication apparatus 1 and the apparatus of the communication destination. In such a case, such a fact that an address of the information communication apparatus 1 has changed in the apparatus of the communication destination is detected; this detection result is transmitted to the information communication apparatus 1; and the actual address change detecting unit 13 may also detect the change in the actual address of the information communication apparatus 1 based upon this transmitted detection result.

(3) Detection Based Upon a Change in a Source Address of a Packet Transmitted from an Apparatus of a Communication Destination:

Although an actual address as to an apparatus of a communication destination with respect to the information communication apparatus 1 has already changed, there are some cases that a packet transmitted from the apparatus of this communication destination may be received by the information communication apparatus 1. For instance, as the above-described case, there is such a case that an NAT, or the like is not present between the information communication apparatus 1 and the apparatus of the communication destination. In such a case, the actual address change detecting untie 13 may detect the change in the actual address of the apparatus of the communication destination based upon such a fact that the source address of the packet transmitted from the apparatus of the communication destination has changed.

(4) Detection Made by Confirming an Actual Address which has Been Set to the Information Communication Apparatus 1:

An actual address of the information communication apparatus 1 has been set in, for example, a register of the communication processing unit 16, an environmental variable, and the like (will be discussed later). The actual address change detecting unit 13 confirms whether or not an actual address has changed which has been set to this register, or the like, and if the actual address has changed, then the actual address change detecting unit 13 may alternatively detect the change in the actual address of the information communication apparatus 1. There is no restriction as to such a timing when the actual address change detecting unit 13 confirms whether or not the actual address has changed which has been set in the above-explained register, or the like. For instance, the actual address change detecting unit 13 may confirm whether or not the actual address has changed in a periodic manner (for example, every time 10 seconds have elapsed, 30 seconds have passed, and the like), or may alternatively confirm whether or not the actual address has changed in response to such a trigger issued when a predetermined event occurs. As the predetermined event, for example, the below-mentioned various sorts of events may be conceived: Any information has not been transmitted from the information communication apparatus 1; a resource term of an address leased by a DHCP server has expired; and other sorts of events occur.

It should also be noted that when the actual address change detecting unit 13 detects a change in an actual address as to an apparatus of a communication destination, the actual address change detecting unit 13 may alternatively detect a change in such an actual address corresponding to specific information, while the specific information is such an information for specifying the apparatus of the communication destination. Also, it should be understood that as methods capable of acquiring actual addresses of communication destination apparatuses after having changed, for example, the below-mentioned methods may be conceived: That is, the actual address change detecting unit 13 interrogates an actual address corresponding to specific information with respect to a server, or the like, which has specific information and actual addresses in correspondence with each other, and thereafter, acquires an actual address of the communication destination apparatus after having changed based upon an answer in response to this interrogation; the actual address change detecting unit 13 accepts specific information and an actual address of a communication destination apparatus after having changed in either a direct manner or an indirect manner from the communication destination apparatus; and other methods. In this case, the above-described specific information corresponding to the information for specifying the communication destination apparatus may be realized in the form of, for instance, an apparatus ID for identifying an apparatus; a telephone number applied in correspondence with an apparatus; a nickname as to an apparatus; a tunnel ID for identifying a tunnel communication executed between the information communication apparatus 1 and a communication destination apparatus, or other items. For example, in such a case that the specific information is a tunnel ID, while this tunnel ID and an apparatus have been stored in a predetermined server in correspondence with each other, the actual address detecting unit 13 may specify the apparatus based upon the tunnel ID in accordance with the corresponding relationship.

In the case that the actual address change detecting unit 13 detects a change in an actual address, the address updating unit 14 updates address correspondence information which has been stored in the address correspondence information storage unit 12 in response to this detected change. It should be understood that updating of this address correspondence information may be carried out in such a case that the actual address change detecting unit 13 has detected all of changes in actual addresses, or may be alternatively carried out in the case where the actual address change detecting unit 13 has detected a portion of the changes in the actual addresses. As the former detection, for instance, there is such a case that the actual address change detecting unit 13 detects changes in actual addresses of communication destination apparatuses. As the latter detection, for example, there is such a case that the actual address change detecting unit 13 detects both a change in the actual address of the information communication apparatus 1, and a change in an actual address of a communication destination apparatus. In this case, the address updating unit 14 may alternatively update the address correspondence information in response only to the change in the actual address of the communication destination apparatus detected by the actual address change detecting unit 13.

The virtual communication processing unit 15 constructs virtual communication data by employing the communication data accepted from the information processing unit 11 based upon the transmission request issued from the information processing unit 11. Also, the virtual communication processing unit 15 acquires an actual address from the address correspondence information, while the actual address corresponds to the virtual address accepted from the information processing unit 11. The acquisition of this actual address is carried out by retrieving the address correspondence information that has been stored in the address correspondence storage unit 12. The virtual communication processing unit 15 performs a communication data processing operation related to the virtual communication data by employing this acquired actual address. In this communication data processing operation, for instance, both the constructed virtual communication data and the acquired actual address may be alternatively passed to the communication processing unit 16 (will be explained later). Even in such a case that the actual address change detecting unit 13 has detected the change in the actual address, the virtual communication processing unit 15 continuously executes the communication data processing operation. The communication data processing operation to be continuously executed by the virtual communication processing unit 15 may be alternatively realized by executing, for instance, a process operation for accepting the communication data and the like from the information processing unit 11. Alternatively, the virtual communication processing unit 15 may accept data transmitted to the information communication apparatus 1 from the communication processing unit 16.

The virtual communication processing unit 15 may construct virtual communication data which contains the virtual address and the communication data, which have been accepted from the information processing unit 11, or may alternatively construct such a virtual communication data which contains the communication data accepted from the information processing unit 11, but does not contain the virtual address. The former data construction corresponds to, for example, the tunnel mode in the IPsec, whereas the latter data construction corresponds to, for instance, the transport mode in the IPsec. In the present embodiment mode, a description will be mainly made of the former data construction case.

Also, in the case that such a fact that the actual address of the information communication apparatus 1 has not been present from the actual address change detecting unit 13 is notified to the virtual communication processing unit 15, the virtual communication processing unit 15 thereafter may not execute such a process operation for passing the virtual communication data to the communication processing unit 16 until such a fact that a new actual address has been set is notified thereto. Further, in the case that such a fact that an actual address of a communication destination apparatus has not been present from the actual address change detecting unit 13 is notified to the virtual communication processing unit 15, the virtual communication processing unit 15 thereafter may not execute such a process operation for passing the virtual communication data to the communication processing unit 16 until such a fact that a new actual address has been set is notified thereto.

Moreover, in such a case that a communication with employment of an actual address has been cut off, the virtual communication processing unit 15 establishes a communication with employment of an actual address with respect to a communication destination. Establishing of the communication implies such a condition that information transmitted from the information communication apparatus 1 is received by an apparatus of the communication destination, and information transmitted from the apparatus of the communication destination is received by the information communication apparatus 1. Alternatively, the virtual communication processing unit 15 may establish a communication between the own information communication apparatus 1 and such an apparatus which is specified by specific information, while this specific information corresponds to such an information for specifying an apparatus of a communication destination to which the information communication apparatus 1 was communicated before the communication with employment of the actual address has been cut off. Since the above-described communication is established, even when the communication with the communication destination apparatus has been cut off, the information communication apparatus 1 can again perform a communication with respect to the communication destination apparatus which was communicated with the information communication apparatus 1 before the communication has been cut off. In this case, the above-explained specific information is similar to the specific information explained in the foregoing description.

For instance, in the case that a communication with employment of an actual address has been cut off since the actual address of the communication destination apparatus changed, the virtual communication processing unit 15 interrogates a new actual address for the communication destination apparatus with respect to a predetermined server apparatus, and then, accepts this new actual address, so that a communication may be established. In such a case, there is no restriction as to means for acquiring the actual address of the communication destination apparatus after having changed by the virtual communication processing unit 15. As a concrete method capable of establishing a communication by two pieces of apparatuses, for example, a method with employment of the SIP (Session Initiation Protocol) may be utilized; methods described in the respective below-mentioned publications may be alternatively employed; and other methods may be employed. In such a case that an apparatus having an NAT (Network Address Translation) function is located between the information communication apparatus 1 and the apparatus of the communication destination, in particular, the methods described in the respective below-mentioned publications may become effective.

Publication 1: J. Rosenberg, J. Weinberger, C Huitema, R. Mahy, [STUN—Simple Traversal of User Datagram Protocol (UDP) Through Network Address Translators (NATs)], March 2003, Network Working Group Request for Comments: 3489, <URL:http://www.ietf.org/rfc/rfc3489.txt>

Publication 2: JP-A-2004-180003

Publication 3: WO 2005/041500

Publication 4: WO 2005/046143

It should also be noted that the virtual communication processing unit 15 may alternatively establish a communication with respect to an apparatus of a communication destination not only when a communication has been cut off, but also when a communication is commenced. The apparatus of the communication destination with which the communication is established may be realized as, for instance, a terminal apparatus that is similar to the information communication apparatus 1, or a server such as a Web server, a database server, and a relay server. Alternatively, a communication which is established by the virtual communication processing unit 15 may be realized as such a communication which is carried out between terminal apparatuses without via a server, or the like, which is referred to as a so-called “P2P communication (pier-to-pier communication).”

The communication processing unit 16 accepts both virtual communication data and an actual address from the virtual communication processing unit 15, and performs a communication processing operation by employing the accepted virtual communication data and the accepted actual address. In other words, the communication processing unit 16 executes a process operation for transmitting the virtual communication data, while the actual address accepted from the virtual communication processing unit 15 is employed as a transmission destination. Concretely speaking, the communication processing unit 16 may alternatively construct such a packet and may alternatively transmit the constructed packet. In this packet, the virtual communication data is contained in a payload thereof, and the actual address accepted from the virtual communication processing unit 15 is contained in a header thereof as an address of the transmission destination. Also, the communication processing unit 16 may alternatively receive data which has been transmitted to the information communication apparatus 1. Also, the communication processing unit 16 may hold the actual address of the information communication apparatus 1. It should be understood that the communication processing unit 16 may hold this actual address in, for example, a register, an environmental variable, a main memory, or the like.

Also, in the case that such a fact that the actual address of the information communication apparatus 1 has not been present is notified from the actual address change detecting unit 13, the communication processing unit 16 thereafter may not perform a communication processing operation related to the virtual communication data accepted from the virtual communication processing unit 15 until such a fact that a new actual address has been set is notified to the communication processing unit 16. Further, in the case that such a fact that the actual address of the information communication apparatus 1 has changed is notified from the actual address change detecting unit 13, the communication processing unit 16 may alternatively read out the actual address after having changed from a register, or the like where this changed actual address has been set.

It should also be noted that the communication processing unit 16 may contain a communication device (for example, modem, network card etc.) so as to perform a communication, or alternatively may not contain such a communication device (in this case, communication device not shown is located between communication processing unit 16 and communication line). Also, the communication processing unit 16 may be realized by hardware, or may be alternatively realized by software such as a driver program capable of driving the communication device.

Next, a description is made of operations of the information communication apparatus 1 according to the present embodiment mode with reference to a flow chart of FIG. 2. It is now assumed that a communication of information corresponds to a packet communication that is carried out by employing a packet.

(step S101) The information processing unit 11 judges whether or not data is transmitted. Then, in the case that the data is transmitted, the process operation is advanced to a step S102. In such a case that the data is not transmitted, the process operation is advanced to a step S103.

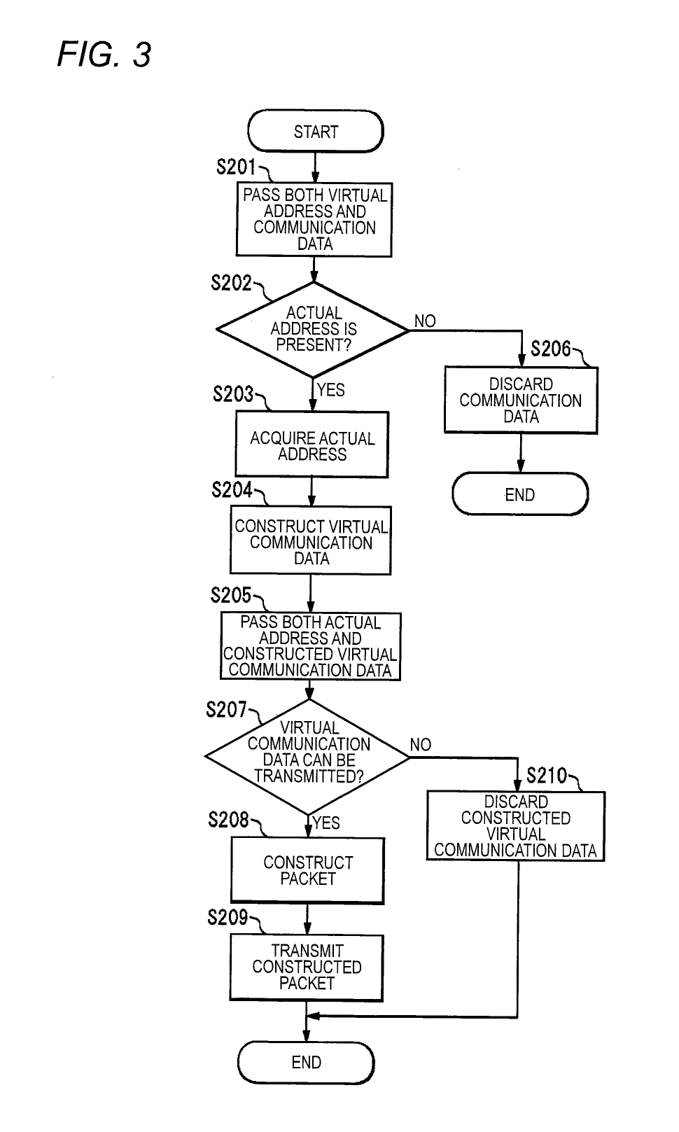

(step S102) The information processing unit 11, the virtual communication processing unit 15, and the communication processing unit 16 perform a transmitting process operation of the data. Then, the process operation is returned to the step S101. It should be noted that the above-described transmitting process operation will be described with reference to a flow chart of FIG. 3.

(step S103) The communication processing unit 16 judges whether or not the data has been received. Then, in the case that the data has been received, the process operation is advanced to a step S104. In such a case that the data has not been received, the process operation is advanced to a step S105.

(step S104) The communication processing unit 16, the virtual communication processing unit 15, and the information processing unit 11 perform a receiving process operation of the data. Since this receiving process operation is similar to the conventional receiving process operation, a detailed explanation thereof will be omitted. Then, the process operation is returned to the step S101.

(step S105) The actual address change detecting unit 13 judges whether or not a change in the actual address has been detected. Then, in such a case that the change in the actual address has been detected, the process operation is advanced to a step S106. In the case that the change in the actual address has not been detected, the process operation is returned to the step S101.

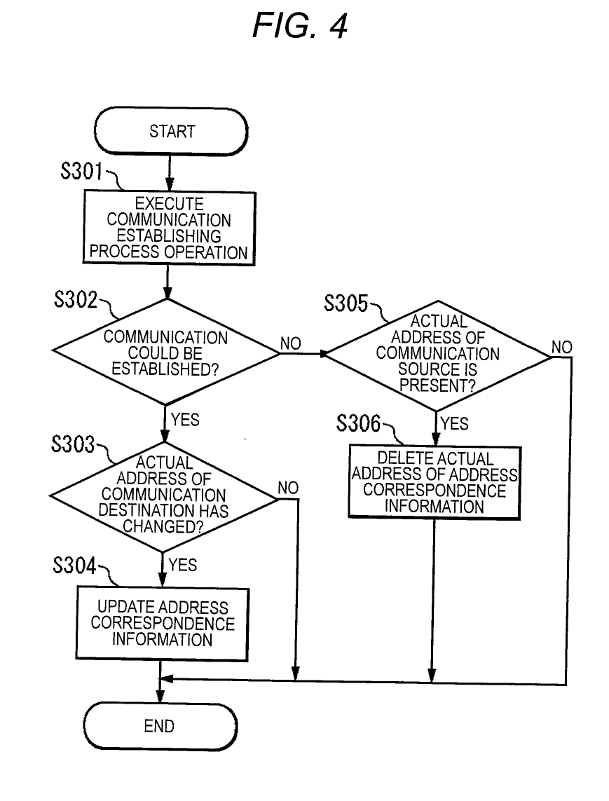

(step S106) The address updating unit 14 and the like execute a process operation in response to the change in the actual address. Then, the process operation is returned to the step S101. It should also be noted that the process operation executed in response to the change in the actual address will be discussed later with reference to a flow chart shown in FIG. 4.

It should also be understood that in the flow chart of FIG. 2, the process operation is accomplished when the power supply is turned OFF, or when an interrupt for accomplishing the process operation is issued.

FIG. 3 is a flow chart for describing detailed contents of the transmitting process operation defined in the step S102 of the flow chart shown in FIG. 2

(step S201) The information processing unit 11 passes both communication data corresponding to data to be communicated, and a virtual address corresponding to an address of a transmission destination of this communication data to the virtual communication processing unit 15 in order to request the virtual communication processing unit 15 to transmit the passed transmission data.

(step S202) The virtual communication processing unit 15 judges whether or not an actual address corresponding to the virtual address accepted from the information processing unit 11 is present in the address correspondence information which has been stored in the address correspondence information storage unit 12. Then, in the case that the actual address is present in the address correspondence information, the process operation is advanced to a step S203, whereas in such a case that the actual address is not present in the address correspondence information, the process operation is advanced to a step S206.

(step S203) The virtual communication processing unit 15 acquires such an actual address corresponding to the virtual address accepted from the information processing unit 11 from the address correspondence information which has been stored in the address correspondence information storage unit 12.

(step S204) The virtual communication processing unit 15 constructs virtual communication data by employing both the communication data and the virtual address which are accepted from the information processing unit 11.

(step S205) The virtual communication processing unit 15 passes both the actual address acquired in the step S203 and the virtual communication data constructed in the step S204 to the communication processing unit 16. This passed actual address constitutes an address as to a transmission destination of the virtual communication data.

(step S206) The virtual communication processing unit 15 discards the communication data accepted from the information processing unit 11. Then, a series of the transmitting process operations is accomplished, so that the process operation is returned to the step S101. It should also be noted that such a fact that this communication data has been discarded is not notified to the information processing unit 11. As a consequence, it is so assumed that the information processing unit 11 continuously performs such a process operation related to the communication with respect to the communication destination.

(step S207) The communication processing unit 16 judges whether or not the virtual communication data accepted from the virtual communication processing unit 15 can be transmitted. For instance, when the actual address of the information communication apparatus 1 is not present, the communication processing unit 16 may judge that the virtual communication data cannot be transmitted. Then, in the case that the virtual communication data can be transmitted, the process operation is advanced to a step S208, whereas in such a case that the virtual communication data cannot be transmitted, the process operation is advanced to a step S210.

(step S208) The communication processing unit 16 constructs such a packet that the virtual communication data accepted from the virtual communication processing unit 15 is contained in a payload thereof, and the actual address accepted from the virtual communication processing unit 15 is contained in a header thereof as an address of a transmission destination.

(step S209) The communication processing unit 16 transmits the constructed packet via either a wired communication line or a wireless communication line to an apparatus of a communication destination. Then, a series of the transmitting process operations is accomplished, so that the process operation is returned to the step S101.

(step S210) The communication processing unit 16 discards the virtual communication data. Then, a series of the transmitting process operations is accomplished, so that the process operation is returned to the step S101. It should also be noted that such a fact that this virtual communication data has been discarded is not notified to the information processing unit 11. As a consequence, it is so assumed that the information processing unit 11 continuously performs such a process operation related to the communication with respect to the communication destination.

It should also be understood that in the flow chart of FIG. 3, the virtual communication data may be alternatively constructed before the actual address is acquired. For instance, the process operation defined in the step S204 may be alternatively executed before the process operation defined in the step S202 is carried out. In this alternative case, assuming now that the actual address corresponding to the virtual address is not present (namely, assuming now that judgment result is “NO” in step S202), the constructed virtual communication data itself is discarded.

FIG. 4 is a flow chart for describing detailed contents of the process operation executed in response to the change in the actual address of the step S106 defined in the flow chart of FIG. 2.

(step S301) The virtual communication processing unit 15 executes a process operation for establishing a communication in order to restart an interrupted communication with respect to an apparatus of a communication destination. It should also be understood that, for example, in such a case that the actual address of the information communication apparatus 1 has changed in this process operation, such a process operation for registering the changed actual address to a predetermined server, or the like may be alternatively carried out.

(Step S302) The virtual communication processing unit 15 judges whether or not a communication could be established with respect to an apparatus of a communication destination. Then, in the case that the communication could be established, the process operation is advanced to a step S303, whereas in such a case that the communication could not be established, the process operation is advanced to a step S305.

(Step S303) The address updating unit 14 judges whether or not the actual address of the communication destination in the communication established by the virtual communication processing unit 15 is identical to the actual address of the communication destination apparatus in the address correspondence information stored in the address correspondence information storage unit 12. For example, in such a case that both an actual IP address and an actual port number are contained in the actual address, assuming now that at least one of the actual IP address and the actual port number, which correspond to the communication destination apparatus after the communication has been established, is different from that of the address correspondence information, the address updating unit 14 judges that the actual address of the communication destination apparatus has changed. Then, in the case that the actual address of the communication destination apparatus has changed, the process operation is advanced to a step S304, whereas in such a case that at least one of the actual IP address and the actual port number is identical to that of the address correspondence information, the series of process operations in response to the change in the actual address is accomplished, so that the process operation is returned to the step S101.

(Step S304) The address updating unit 14 updates the actual address of the communication destination in the address correspondence information to become the actual address after has changed. Then, the series of process operations in response to the change in the actual address is accomplished, so that the process operation is returned to the step S101.

(Step S305) The actual address change detecting unit 31 judges whether or not the actual address of the information communication apparatus 1 is present. For example, this judgment may be made by confirming whether or not the actual address held in the communication processing unit 16 is present. Then, in the case that the actual address of the information communication apparatus 1 is present, the process operation is advanced to a step S306. To the contrary, in such a case that the actual address of the information communication apparatus 1 is not present, the above-described series of process operations in response to the change in the actual address is accomplished, so that the process operation is returned to the step S101.

(Step S306) The address updating unit 14 deletes an actual address of a communication destination apparatus in the address correspondence information. In the case where such a judgment is made that the actual address of the information communication apparatus 1 is not present in the judging process operation of the step S305, the reason why the communication could not be established may be conceived as follows: That is, the actual address of the communication destination apparatus has not been present. Then, the above-described series of process operations in response to the change in the actual address is accomplished, so that the process operation is returned to the step S101.

It should also be understood that in the above-described flow chart of FIG. 4, the judgment of the step S305 is executed in order to judge whether the reason why the communication could not be established is caused by such a fact that the actual address of the communication destination apparatus has not been present, or by such a fact that the actual address of the information communication apparatus 1 has not been present. As a consequence, when the communication could not be established in the above-explained communication establishing process operation of the step S301, in such a case that it is possible to detect that the communication could not be established by which reason in this communication establishing process operation, such a judgment may be alternatively made by employing the detected information as to whether the process operation defined in the step S305 is advanced to the step S306, or is returned to the step S101.

Also, in the flow chart of FIG. 4, in the case that it is so judged that the communication could be established in the step S302, the actual address of the communication destination where the communication could be established may be alternatively overwritten on the address correspondence information in the step S304 without confirming whether or not the actual address of the communication destination has changed in the step S303. In this alternative case, when the actual address of the communication destination has not changed, even if the above-described actual address of the communication destination is overwritten on the address correspondence information, this address correspondence information does not change.

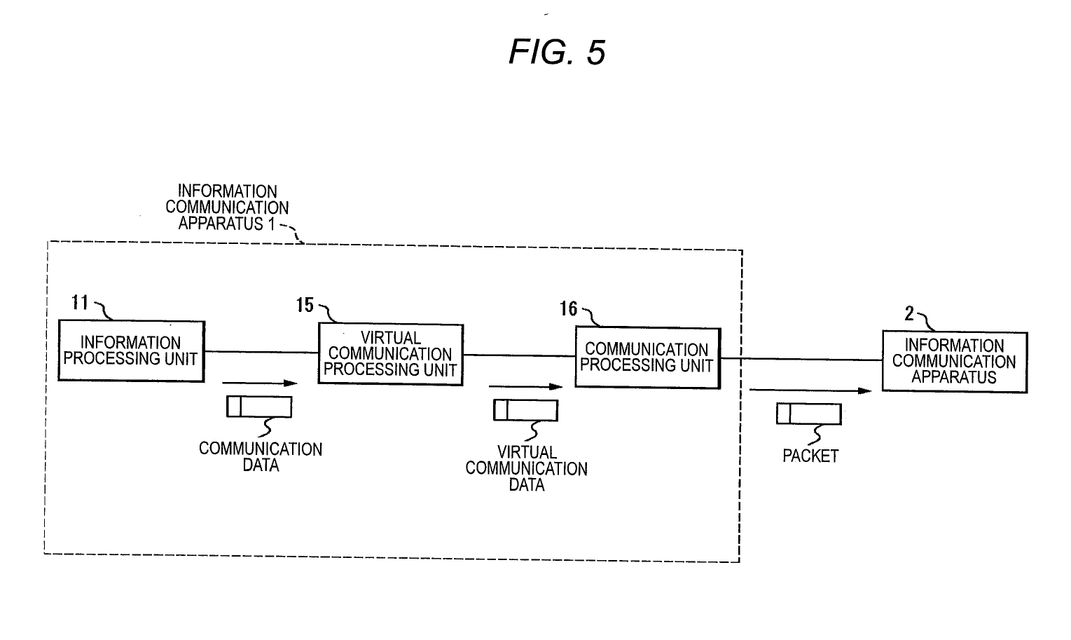

Referring now to FIG. 5 to FIG. 7, a description is made of process operations executed in the information communication apparatus 1 according to the present embodiment mode. In the below-mentioned descriptions, it is so assumed that a communication has already been established with employment of an actual address between the above-described information communication apparatus 1 and another information communication apparatus 2 that corresponds to the apparatus of the communication destination thereof.

As represented in FIG. 5, in such a case that the information communication apparatus 1 can be communicated with the information communication apparatus 2 of the communication destination, communication data is passed from the information processing unit 11 to the virtual communication processing unit 15; virtual communication data is constructed in the virtual communication processing unit 15 and the constructed virtual communication data is passed to the communication processing unit 16; and a packet is transmitted from the communication processing unit 16 to the information communication apparatus 2. Thus, the communication is carried out between the information communication apparatus 1 and the information communication apparatus in the above-explained manner.

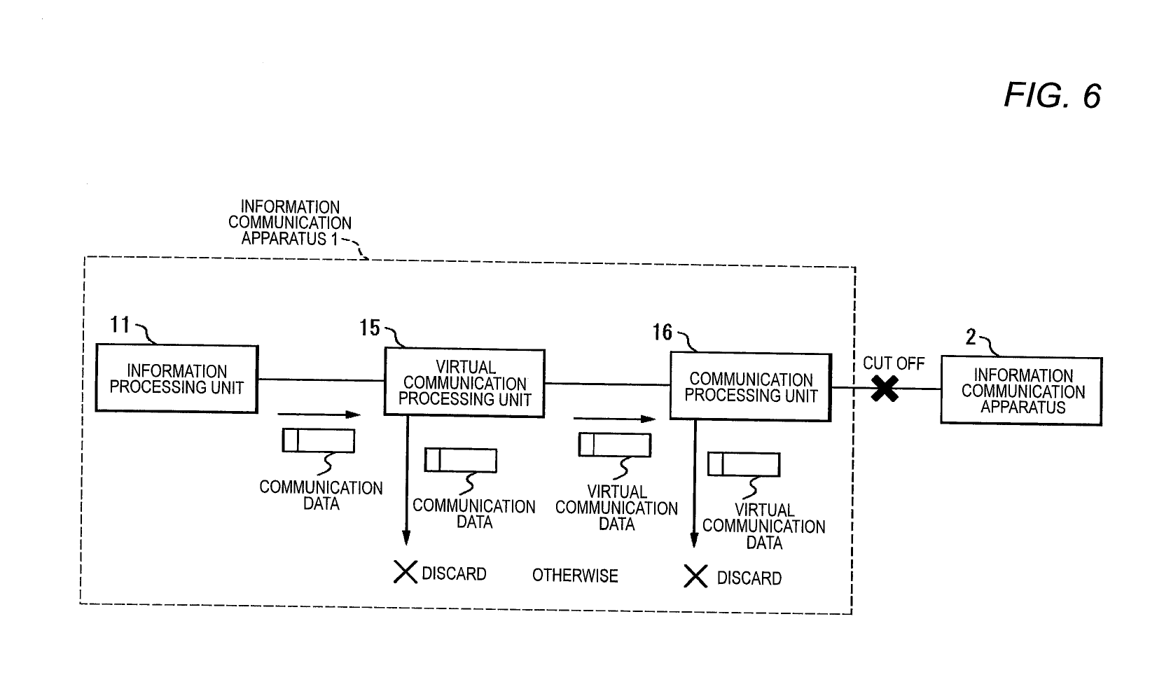

On the other hand, in the case that the communication established between the information communication apparatus 1 and the information communication apparatus 2 is cut off due to a certain reason, as indicated in FIG. 6, although the communication data is passed from the information processing unit 11 to the virtual communication processing unit 15, this communication data is discarded in the virtual communication processing unit 15. Otherwise, although the communication data is passed from the information processing unit 11 to the virtual communication processing unit 15, the virtual communication data is constructed in the virtual communication processing unit 15, and then, the constructed virtual communication data is passed to the communication processing unit 16, this passed virtual communication data is discarded in the communication processing unit 16. As a consequence, a packet is not transmitted from the communication processing unit 16 to the information communication apparatus 2. It should also be understood that in order that the virtual communication processing unit continuously performs the process operation for accepting the communication data from the information processing unit 11, the information processing unit 11 continuously performs the communication data processing operation without grasping that the communication between the information processing apparatus 1 and the information processing apparatus 2 is cut off. Thereafter, in such a case that the communication between the information communication apparatus 1 and the information communication apparatus 2 is restarted, as shown in FIG. 5, the packet containing the communication data is transmitted from the information communication apparatus 1, so that the communication which had been established with respect to the communication destination before the communication was cut off can be restarted.

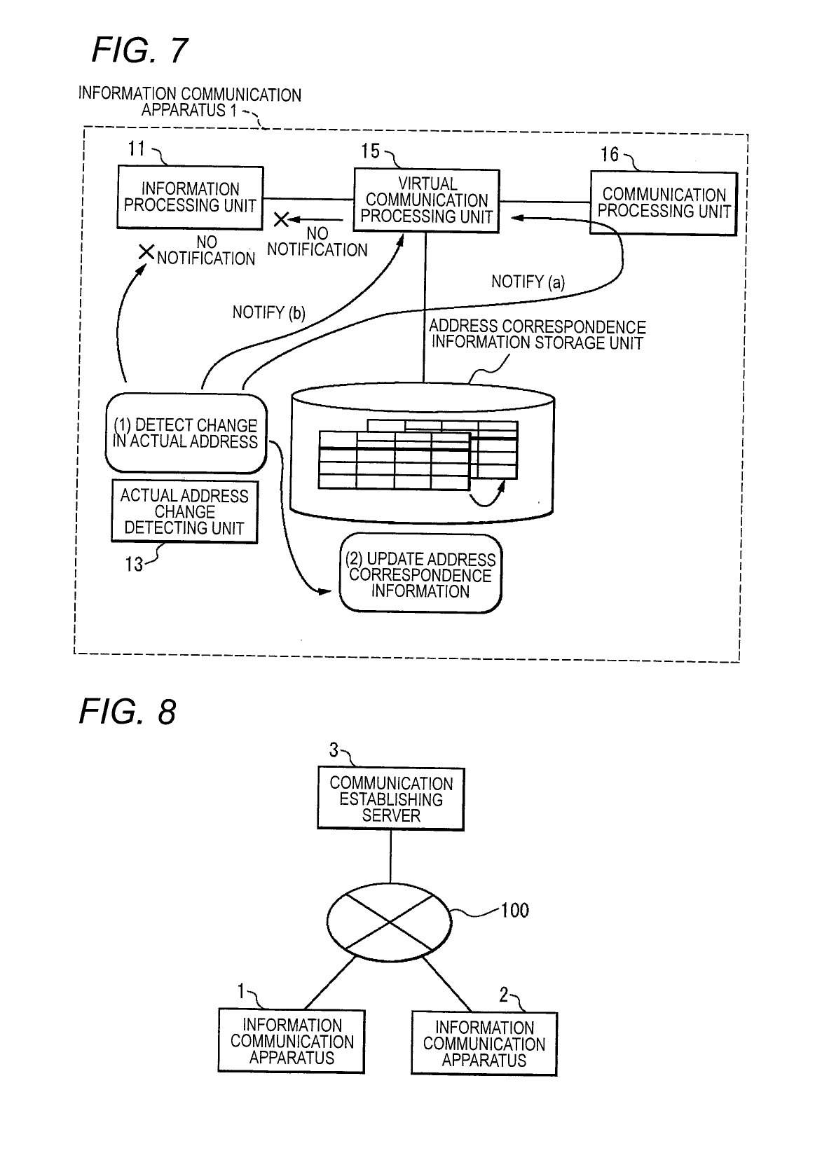

FIG. 7 is an explanatory diagram for explaining process operations executed in the case that a change in an address is detected. When the actual address change detecting unit 13 detects a change in an actual address, the address correspondence information is updated in response to the detection. On the other hand, such a fact that the change in the actual address has been detected is not notified to the information processing unit 11. Also, even if the below-mentioned information notification has been set, namely, as indicated by notification (a), such a fact that the change in the actual address has been detected is notified to the information processing unit 16 and is notified from the virtual communication processing unit 15 to the information processing unit 11, this fact is not notified from the virtual communication processing unit 15 to the information processing unit 11. Further, even if it has been set that such a fact that the change in the actual address has been detected is notified to the virtual communication processing unit 15 as represented as notification (b), this fact is not notified from the virtual communication processing unit 15 to the information processing unit 11. As a consequence, even in such a case where the communication between the information communication apparatus 1 and an apparatus of a communication destination has been cut off due to the change in the actual address, as previously described, the information processing unit 11 continuously performs the communication data processing operation without grasping that the actual address has changed. It should also be noted that as represented by the notification (b), when it has been set that such a fact that the change in the actual address has been detected is notified to the virtual communication processing unit 15, another setting operation may be alternatively performed, namely, it may be alternatively set that such a fact may also be notified to both the virtual communication processing unit 15 and the communication processing unit 16.

Next, a description is made of a concrete example as to the operations of the information communication apparatus 1 according to the present embodiment mode. As shown in FIG. 8, in this concrete example, it is so assumed that the information communication apparatus 1, the information communication apparatus 2, and a communication establishing server 3 have been connected to each other via either a wired communication line 100 or a wireless communication line 100. The communication line 100 corresponds to, for example, the Internet, an Intranet, a public telephone network, and the like. It is also assumed that the information communication apparatus 2 has been equipped with similar structural elements to those of the information communication apparatus 1. Also, a communication apparatus having an NAT function and a communication apparatus having a firewall function may be alternatively located between the information communication apparatus 1 and the communication line 100, and between the information communication apparatus and the communication 100.

In the beginning, a description is made of such a process operation that the information communication apparatuses 1 and 2 register actual addresses to the communication establishing server 3. The virtual communication processing unit 15 of the information communication apparatus 1 passes specific information “T001” for specifying the information communication apparatus 1, such a message that an actual address is registered, a request for transmitting the specific information “T001” and the message to the communication establishing server 3, and an address of the communication establishing server 3 to the communication processing unit 16. It is so assumed that the virtual communication processing unit 15 has previously grasped the address of the communication establishing sever 3. Also, it is assumed that the specific information “T001” of the information communication apparatus 1 has been held in a recording medium (not shown), to which the virtual communication processing unit 15 can access. When the information processing unit 16 accepts the above-explained information, the communication processing unit 16 constructs such a packet, and then, transmits the constructed packet to the communication establishing server 3, while the packet contains both the specific information “T001” and the message for registering the actual address in a payload thereof.

The packet transmitted from the information communication apparatus 1 is received by the communication establishing server 3. Then, the communication establishing server 3 acquires an IP address “111.222.10.10” of a transmission source, and a port number “11223” of the transmission source from the header of this received packet. The acquired IP address and port number correspond to the actual address of the information communication apparatus 1. Also, the communication establishing server 3 acquires the specific information “T001” of the information communication apparatus 1 from the payload of the received packet. Then, in the communication establishing server 3, the specific information of the information communication apparatus 1 and the actual address thereof are stored in a recording medium (not shown) in correspondence with each other. Similarly, the actual address of the information communication apparatus 2 is also registered in the communication establishing server 3. It is also assumed that the specific information of the information communication apparatus 2 is “T0002.”

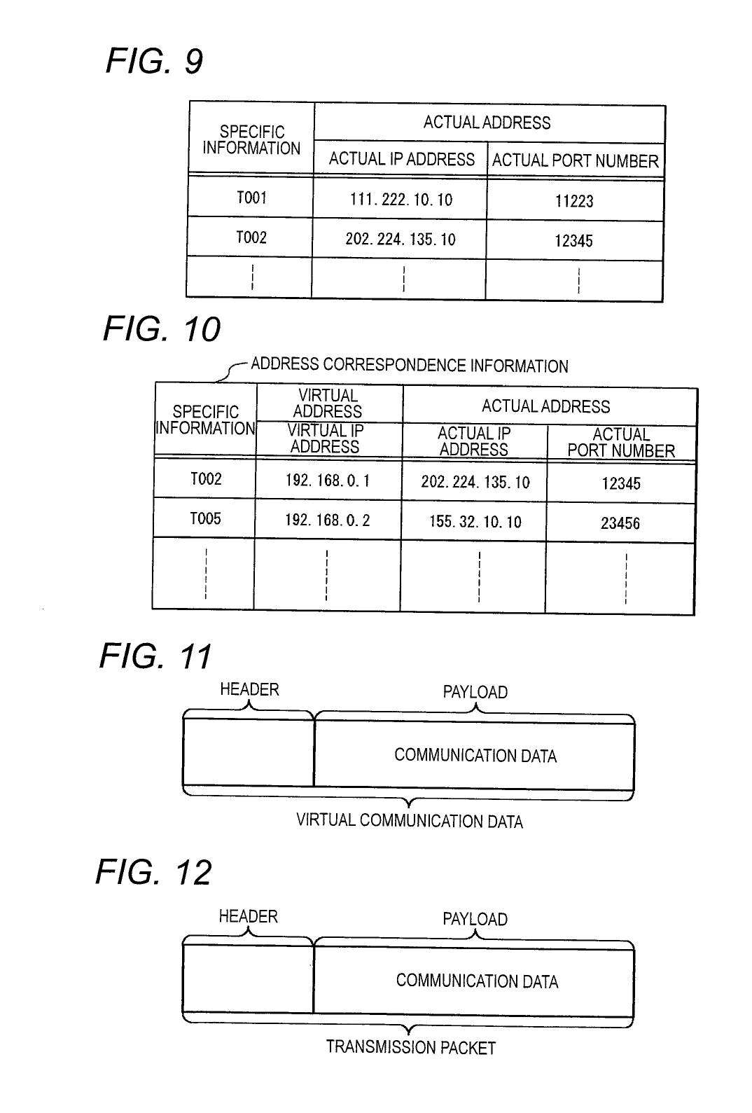

FIG. 9 is a diagram for indicating an example as to a correspondence relationship between actual addresses and specific information, which have been registered in the communication establishing server 3. It should be understood that in such a case where a communication apparatus having an NAT function is present between the information communication apparatuses 1 and 2, and the communication line 100, an actual address as to the WAN side of this communication apparatus is registered in the communication establishing server 3.

Next, a description is made of a process operation performed until a communication between the information communication apparatus 1 and the information communication apparatus 2 is commenced. It should be noted that in this concrete example, a virtual port number which is employed in a communication by the information processing unit 11 has been previously set to “11111.”

Firstly, the information processing unit 11 passes an instruction to the virtual communication processing unit 15, while this instruction instructs that a communication is established with respect to the information communication apparatus 2 which is specified by the specific information “T002.” It should also be noted that this specific information “T002” may be realized as such a specific information entered by a user of the information communication apparatus 1 into the information communication apparatus 1, or as specific information accepted by the information communication apparatus 1 by other methods.

The virtual communication processing unit 15 transmits such a packet via the communication processing unit 16 to the communication establishing server 3, while this packet contains the above-explained specific information “T002”, and such a message that a communication is wanted to be started with the information communication apparatus 2 specified by this specification information “T002.” As a result, the above-described packet is received by the communication establishing server 3. Then, the communication establishing server 3 acquires an actual address corresponding to the specific information “T002.” The communication establishing server 3 issues both a virtual IP address “192.168.0.10” which corresponds to the information communication apparatus 1, and another virtual IP address “192.168.0.1” which corresponds to the information communication apparatus 2. Issuing of the virtual IP addresses may be alternatively carried out by employing a virtual address-purpose DHCP (Dynamic Host Configuration Protocol) server, or the like.

Thereafter, the communication establishing server 3 transmits the actual address of the information communication apparatus 2 specified by the specific information “T002”, the virtual IP address allocated to the information communication apparatus 1, and the virtual IP address allocated to the information communication apparatus 2 with respect to the information communication apparatus 1. Also, similarly, the communication establishing server 3 transmits the actual address of the information communication apparatus 1 which has issued the communication establishing request, the virtual IP address allocated to the information communication apparatus 1, and the virtual IP address allocated to the information communication apparatus 2 with respect to the information communication apparatus 2.

The communication processing unit 16 of the information communication apparatus 1 receives such a packet which contains the actual address of the information transmitted from the communication establishing server 3, the virtual IP address allocated to the information communication apparatus 1, and the virtual IP address allocated to the information communication apparatus 2. Then, the actual address of the information processing apparatus 2 transmitted from the communication establishing server 3, the virtual IP address allocated to the information communication apparatus 1, and the virtual IP address allocated to the information communication apparatus 2 are passed to the virtual communication processing unit 15, while these actual address and virtual addresses are contained in the received address.

The virtual communication processing unit 15 passes the virtual IP address of the information communication apparatus 2 to the information processing unit 11. Thus, the information processing unit 11 can grasp the virtual IP address as to the apparatus of the communication destination in the above-described manner. Alternatively, the above-described virtual IP address may be held in, for example, a recording medium (not shown). Also, the virtual communication processing unit 15 passes the actual address of the information communication apparatus 2, the virtual IP address of the information communication apparatus 2, and the specific information “T002” of the information communication apparatus 2 to the address updating unit 14. As a result, the address updating unit 14 stores the specific information, the actual address, and the virtual IP address in the address correspondence information that has been stored in the address correspondence information storage unit 12 in correspondence with each other. A first record shown in FIG. 10 is the address correspondence information that has been stored in the above-explained manner.

Also, the virtual communication processing unit 15 passes the virtual IP address of the information communication apparatus 1 to the virtual communication processing unit 15. The virtual communication processing unit 15 holds this passed virtual IP address as the virtual IP address of the information communication apparatus 1. It is so assumed that such process operations similar to these process operations executed in the information communication apparatus 1 are carried out also in the information communication apparatus 2.

Next, a description is made of process operations executed until a packet is transmitted from the information communication apparatus 1. Firstly, it is so assumed that the information processing unit 11 judges that data is transmitted (step S101). Accordingly, the information processing unit 11 passes communication data, the virtual IP address “192.168.0.1” of the information communication apparatus 2 corresponding to a transmission destination of this communication data, and the virtual port number “11111” of the information communication apparatus 2 to the virtual communication processing unit 15 (step S201). The virtual communication processing unit 15 refers to the address correspondence information represented in FIG. 10 so as to judge whether or not there are both an actual IP address, which corresponds to the accepted virtual IP address, and an actual port number (step S202). In this case, since the first record of FIG. 10 is present, the virtual communication processing unit 15 judges that the actual address corresponding to the accepted virtual address is present, and thus, acquires both an actual IP address “192.168.0.10” and an actual port number “12345”, which corresponds to this accepted virtual address (step S203). Also, the virtual communication processing unit 15 constructs such a packet that the accepted communication data is contained in a payload thereof, the accepted virtual IP address and the accepted virtual port number of the information communication apparatus 2 are contained in a header thereof as an address of a communication destination, and both the virtual IP address “192.168.0.10” and the virtual port number “11111” of the information communication apparatus 1, which have been previously set, are contained in the header as an address of a communication source (step S204). This packet corresponds to virtual communication data. FIG. 11 is a diagram for indicating a structure of the above-explained virtual communication data.

The virtual communication processing unit 15 passes the constructed virtual communication data and the actual address acquired from the address correspondence information to the communication processing unit 16 (step S205). As a result, in such a case that the actual address of the information communication apparatus 1 has been set, the communication processing unit 16 judges that a packet transmission can be performed (step S207), and constructs such a transmission packet that the virtual communication data is contained in a payload thereof, the actual address accepted from the virtual communication processing unit 15 is contained in a header thereof as an actual address of a transmission destination, and the actual address of the information communication apparatus 1 which has been set to the communication processing unit 16 is contained in the header as an actual address of a transmission source (step S208). FIG. 12 is a diagram for indicating a structure of the above-described transmission packet. In this case, the virtual address is contained in the payload of the transmission packet. It should also be noted that the payload of the above-explained transmission packet may be encrypted by employing, for instance, an ESP header, an ESP trailer, and the like. Also, this transmission packet may be authenticated by employing, for example, an ESP authentication trailer. The communication processing unit 16 transmits the above-explained transmission packet (step S209). The transmission packet transmitted in the above-described manner is received by the information communication apparatus 2.

Next, a description is made of a receiving process operation for receiving a transmission packet in such a case that the transmission packet has been transmitted from the information communication apparatus 2 to the information communication apparatus 1. When the communication processing unit 16 of the information communication apparatus 1 receives the transmission packet (step S103), the virtual communication data contained in the payload of this received transmission packet is passed to the virtual communication processing unit 15. Then, the virtual communication processing unit 15 passes the communication data contained in the payload of the packet of this virtual communication data to the information processing unit 11. The receiving process operation is carried out in the above-explained manner (step S104). It should also be understood that since this receiving process operation is similar to a general-purpose receiving process operation (namely, process operation for releasing encapsulation) in such a case that a packet has been encapsulated, a detailed description thereof will be omitted.

Next, a description is made of such a case that changes in actual addresses have been detected. The below-mentioned cases will now be explained as the changes in the actual addresses: (1) In the case that the actual address of the information communication apparatus 1 has been deleted; (2) In the case that the actual address of the information communication apparatus 1 has changed into a new address; (3) In the case that the actual address of the information communication apparatus 2 has been deleted; and (4) In the case that the actual address of the information communication apparatus 2 has changed into a new actual address. It is so assumed that in this concrete example, the actual address change detecting unit 13 detects changes in actual addresses, in particular, that the actual address has changed into the new actual address and the actual address has been deleted by such a manner that a keep alive packet has not been properly transmitted. On the other hand, in the above-described concrete example, it is also assumed that the communication processing unit 16 detects that a new actual address is set by detecting such a fact that the new actual address has been set with respect to the information communication apparatus 1 after the actual address of the information communication apparatus 1 was deleted. Also, it is so assumed that in the above-explained concrete example, the communication processing unit 16 detects that such a process operation for establishing a communication from the information communication apparatus 2 is carried out by detecting such a fact that the new actual address has been applied with respect to the information communication apparatus 2 after the actual address of the information communication apparatus 2 corresponding to the communication destination apparatus was deleted.

(1) In the Case That the Actual Address of the Information Processing Apparatus 1 has Been Deleted:

For example, in such a case that while the information communication apparatus 1 is performing a wireless communication, the information communication apparatus 1 has been moved outside a communication service area of an access point of this wireless communication, an actual address is released which has been set to the information communication apparatus 1, so that the actual address of the information communication apparatus 1 is deleted. Otherwise, although the actual address has been still set to the information communication apparatus 1, the information communication apparatus 1 cannot perform a wireless communication with employment of this actual address, so that the actual address of the information communication apparatus 1 is essentially deleted (this case will also be referred as “actual address has been deleted”). As previously explained, in such a case that the actual address of the information communication apparatus 1 has been deleted, the keep alive packet which has been repeatedly transmitted by the virtual communication processing unit 15 can be no longer transmitted. As a result, since an error occurs in the transmission of the keep alive packet, the actual address change detecting unit 13 detects a change in the actual address (step S105). It should be understood that a judgment for judging that the error has occurred in the communication with which apparatus of communication destination may be made based upon, for example, such a specific information when the specific information of the communication destination apparatus is contained in the keep alive packet, or may be alternatively made by a acquiring such a specific information corresponding to an actual address of a transmission destination of a keep alive packet, and then, by employing the acquired specific information. Then, the actual address change detecting unit 13 passes such a fact that the actual address has changed to the virtual communication processing unit 15. As a result, the virtual communication processing unit 15 executes a process operation for establishing a communication with respect to the information communication apparatus 2 which has so far performed the communication (step S301). It should be understood that since the actual address of the information communication apparatus 1 has already been deleted in this case, the virtual communication processing unit 15 can no longer perform the process operation for establishing this communication. As a consequence, the virtual communication processing unit 15 judges that the communication cannot be established (step S302). Then, the actual address change detecting unit 13 confirms whether or not such an actual address is present which has been held in the communication processing unit 16. In this case, the actual address change detecting unit 13 judges that such an actual address is not present (step S305).

Thereafter, in such a case that the information processing unit 11 judges that the data is transmitted (step S101), the virtual address and the like are passed from the information processing unit 11 to the virtual communication processing unit 15, so that virtual communication data is constructed, and then, the constructed virtual communication data and the like are passed to the communication processing unit 16 (steps S201 to S205). However, since the actual address of the information communication apparatus 1 is not present, the information processing unit 11 judges that the data cannot be transmitted (step S207), so that the virtual communication data is discarded (step S210). Nevertheless, the virtual communication processing unit 15 continuously performs such a process operation for accepting the communication data from the information processing unit 11. As a consequence, the information processing unit 11 never recognizes such a fact that the actual address of the information communication apparatus 1 has been deleted.

Thereafter, for example, when the actual address of the information communication apparatus 1 is again set, the actual address change detecting unit 13 detects this re-setting operation of the actual address, and performs a process operation for establishing a communication with respect to the information communication apparatus 2, so that a communication by the information communication apparatus 1 is established with respect to the information communication apparatus 2 (steps S301 and S302). In this case, since the actual address of the information communication apparatus 2 does not change (step S303), updating of the address correspondence information is not carried out. Then, the communication between the information communication apparatus 1 and the information communication apparatus 2 is restarted. Even in such a case, there is no change in the virtual address of the information communication apparatus 1 and the virtual address of the information communication apparatus 2 as compared with these before the actual address has changed.

(2) In the Case That the Actual Address of the Information Communication Apparatus 1 has Changed into the New Actual Address:

For instance, it is so assumed that an actual address which had been applied from a provider to the information communication apparatus 1 has changed into a new actual address. In the case that the information communication apparatus 2 corresponding to the communication destination apparatus is performing the communication via a communication apparatus having an NAT function under such a situation, there are some possibilities that a keep alive packet transmitted from the information communication apparatus 1 cannot exceed the communication apparatus having the NAT function, but may not reach the information communication apparatus 2. In this case, since a communication error of the keep alive packet is detected, a change in the actual address is detected (step S105).

Then, the actual address change detecting unit 13 passes such a fact that the actual address has changed with respect to the virtual communication processing unit 15. As a result, the virtual communication processing unit 15 executes such a process operation for establishing a communication with respect to the information communication apparatus 2 which has so far executed the communication (step S301). It should also be noted that in this case, since the actual address of the information communication apparatus 1 has changed, the virtual communication processing unit 15 also performs another process operation for changing the actual address corresponding to the information communication apparatus 1, which has been registered in the communication establishing server 3, into a new actual address. Then, it is so assumed that a communication has been established between the information communication apparatus 1 and the information communication apparatus 2 (step S302). It should also be understood that even in such a case, there is no change in the virtual address of the information communication apparatus 1 and the virtual address of the information communication apparatus 2, as compared with those before the actual address has changed. Also, in this example, such an explanation has been made that the virtual communication processing unit 15 performs the process operation for changing the address which has been registered to the communication establishing server 3. Alternatively, the process operation for changing this actual address which has been registered may be carried out by other structural elements than the virtual communication processing unit 15. Further, the process operation for changing this actual address which has been registered may not be alternatively carried out at this time, but may be alternatively carried out later.

The address updating unit 14 judges whether or not the actual address of the information communication apparatus 2 in the communication established by the virtual communication processing unit 15 is identical to the actual address which has been stored in the address correspondence information. In this case, the address updating unit 14 judges that the actual address of the information communication apparatus 2 in the communication established by the virtual communication processing unit 15 is identical to the actual address which has been stored in the address correspondence information (step S303), and thus, does not perform such a process operation for updating the address correspondence information. As previously described, the communication between the information communication apparatus 1 and the information communication apparatus 2 with employment of the virtual address is continuously carried out.

(3) In the Case That the Actual Address of the Information Communication Apparatus 2 has Been Deleted:

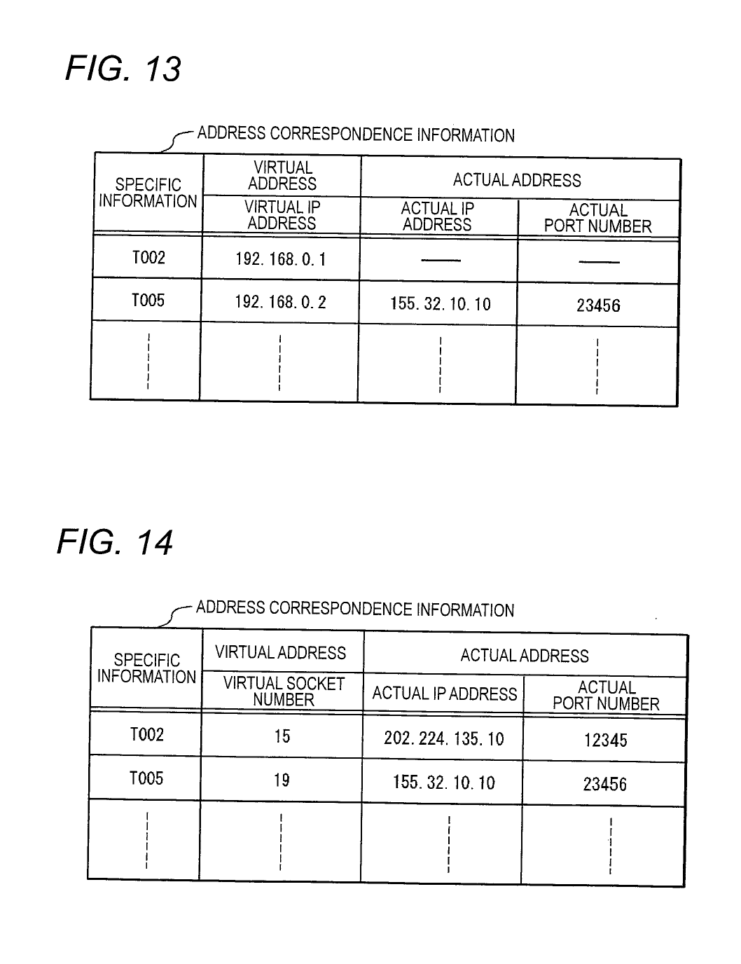

In such a case that the actual address of the information communication apparatus 2 has been deleted, such a keep alive packet which has been repeatedly transmitted by the virtual communication processing unit 15 does not reach the information communication apparatus 2. As a result, the actual address change detecting unit 13 detects a change in the actual address, since an error occurs in the transmission of the keep alive packet (step S105). Then, the actual address change detecting unit 13 passes such a fact that the actual address has changed to the virtual communication processing unit 15. As a result, the virtual communication processing unit 15 executes such a process operation for establishing a communication with respect to the information communication apparatus 2 which has so far performed the communication (step S301). It should be noted that in this case, since the actual address of the information communication apparatus 2 has been deleted, the virtual communication processing unit 15 can no longer execute the process operation for establishing this communication. As a consequence, the virtual communication processing unit 15 judges that the communication cannot be established (step S302). Then, the actual address change detecting unit 13 confirms whether or not there is such an actual address held in the communication processing unit 16, and judges that such an actual address is present in this case (step S305). As a consequence, the address updating unit 14 deletes an actual address which has been defined in correspondence with the specific information “T002” of the information communication apparatus 2 in the address correspondence information (step S306). As a result, the address correspondence information is represented in FIG. 13.

Thereafter, in such a case that the information processing unit 11 judges that the data is transmitted (step S101), the virtual address and the like are passed from the information processing unit 11 to the virtual communication processing unit 15 (step S201). However, since the actual address of the information communication apparatus 2 is not present (step S202), the virtual communication data is discarded (step S206). Nevertheless, the virtual communication processing unit 15 continuously performs such a process operation for accepting the communication data from the information processing unit 11. As a consequence, the information processing unit 11 never recognizes such a fact that the actual address of the information communication apparatus 2 has been deleted.

Thereafter, it is so assumed that the actual address of the information communication apparatus 2 is set, and such a process operation for informing that a communication from the information communication apparatus 2 is established has been carried out. When the execution of this communication establishment informing process operation is detected (step S105), a communication establishing process operation is carried out by the virtual communication processing unit 15 (step S301). In this case, it is so assumed that this communication has been established (step S302). As a result, the address updating unit 14 accepts the actual address of the information communication apparatus 2 from the virtual communication processing unit 15, and judges that the actual address of the communication destination has changed (step S303), and then, stores this new actual address in the address correspondence information in correspondence with the specific information “T002” of the information communication apparatus 2 (step S304). Then, a communication is restarted between the information communication apparatus 1 and the information communication apparatus 2. It should also be noted that even in such a case, there is no change in the virtual address of the information communication apparatus 1, and the virtual address of the information communication apparatus, as compared with those 2 before the actual addresses have changed.

(4) In the Case That the Actual Address of the Information Communication Apparatus 2 has Changed into a New Actual Address:

For instance, it is so assumed that an actual address which had been applied from the provider to the information communication apparatus 2 has changed into a new actual address. As a result, the keep alive packet which has been transmitted to the actual address of the information communication apparatus 2 indicated based upon the address correspondence information can no longer reach the information communication apparatus 2, and a communication error is detected, so that the change in the actual address is detected (step S105).

Then, the actual address change detecting unit 13 passes such a fact that the actual address has changed with respect to the virtual communication processing unit 15. As a result, the virtual communication processing unit 15 executes a process operation for establishing a communication with respect to the information communication apparatus 2 which has so far performed the communication (S301). Then, it is so assumed that the communication has been established between the information communication apparatus 1 and the information communication apparatus 2 (step S302). It should also be noted that even in such a case, there is no change in the virtual address of the information communication apparatus 1, and the virtual address of the information communication apparatus 2, as compared with those before the actual addresses have changed.

The address updating unit 14 judges whether or not the actual address of the information communication apparatus 2 in the communication established by the virtual communication processing unit 15 is identical to the actual address which has been stored in the address correspondence information. In this case, the address updating unit 14 judges that the actual address of the information communication apparatus 2 in the communication established by the virtual communication processing unit 15 is different from the actual address which has been stored in the address correspondence information (step S303), so that the actual address of the information communication apparatus 2 is updated as a new actual address (step S304). As previously described, the communication between the information communication apparatus 1 and the information communication apparatus 2 with employment of the virtual address is continuously carried out.

In this concrete example, the below-mentioned correspondence relationships may be conceived: For example, the process operation executed in the information processing unit 11 corresponds to a process operation executed in an application layer; the process operation executed in the virtual communication processing unit 15 corresponds to each of process operations executed in a transport layer and a network layer related to the virtual communication data (namely, packet to be encapsulated); and also, the process operation executed in the communication processing unit 16 corresponds to each of process operations executed in a transport layer, a network layer, and a data link layer related to a packet transmitted from the information communication apparatus 1. In this case, the process operation executed in the physical layer may be alternatively contained in the process operation executed in the communication processing unit 16. Alternatively, a structural element (not shown) that is located between the communication processing unit 16 and the communication line may execute the process operation executed in the physical layer. It should also be noted that the correspondence relationship between the respective structural elements and the respective hierarchical layers are merely provided as one example, and therefore, other correspondence relationships may be apparently established. For example, the process operation executed in the virtual communication processing unit 15 may alternatively correspond to each of the process operations executed in the transport layer, the network layer, and the data link layer related to the virtual communication data. In this alternative case, for instance, the virtual communication data may contain a header of the Ethernet (registered trademark).

It should also be understood that the above-explained concrete example has described such a case that in the server other than each of the information communication apparatuses 1 and 2, the virtual IP address has been determined. Alternatively, the virtual IP address may be determined based upon other methods. For instance, the virtual IP address may be alternatively determined in each of these information communication apparatuses 1 and 2 by employing the method disclosed in the publication WO/2005/074208.

Also, the above-described concrete example has explained such a case that since the information processing unit 11 has passed both the communication data and the virtual address of the communication destination with respect to the virtual communication processing unit 15, the communication process operation related to the communication data has been carried out. As apparent from the foregoing description, the information processing unit 11 may alternatively perform the communication process operation as a socket communication.

Also, the above-explained concrete example has described such a case that the virtual address contained in the address correspondence information corresponds to the virtual IP address. As shown in FIG. 14, a virtual socket number may be alternatively employed as the virtual address. This virtual socket number has been defined in correspondence with the virtual IP address and the virtual port number separately. Alternatively, the actual address contained in the address correspondence information may correspond to the socket number.

Also, the above-explained concrete example has described such a case that the virtual port number has been previously determined. Alternatively, the virtual port number may not be previously determined, but may be determined by the virtual communication processing unit 15, or the like when a communication is carried out. In this alternative case, the information processing unit 11 may alternatively interrogate a virtual port number with respect to the virtual communication processing unit 15, or may check a packet transmitted from a reflect server so as to grasp this virtual port number. In this case, the above-described reflect server implies such a server which reads out the virtual port number and the like from headers of packets contained in payloads of packets transmitted via the information processing unit 11, the virtual communication processing unit 15, and the communication processing unit 16, and this server constructs such a packet that the read virtual port number and the like are contained in a payload thereof, and then, transmits such a return packet that the constructed packet is contained in a payload thereof with respect to the information communication apparatus 1. This return packet is received by the information communication processing unit 11, and then, the payload of the packet contained in the payload of the return packet is passed to the information processing unit 11, so that the information processing unit 11 may grasp the virtual port number. Also, the information processing unit 11 may grasp the virtual IP address by executing a similar method. It is assumed that an address of a header of a packet contained in the payload of this return packet has been provided as such an address used in the case that the reflect server transmits the return packet with respect to the address of the header of the packet contained in the payload of the packet received from the information communication apparatus 1. Normally, it is such an address that a transmission destination address and a transmission source address have been reversed. In such a case, it is so assumed that the information processing unit 11 receives the virtual port number employed in the information communication apparatus 2 of the communication destination from the information communication apparatus 2 of this communication destination. The above-explained virtual port number may be directly transmitted from the information communication apparatus 2 to the information communication apparatus 1, otherwise, may be alternatively transmitted via the communication establishing server 3, and the like. Alternatively, while the virtual port numbers of the respective information communication apparatuses 1 and 2 have been managed by the communication establishing server 3 in such a case that the information communication apparatus 1 has acquired the actual address of the information communication apparatus 2, the virtual port number may be alternatively acquired by the information communication apparatus 1.

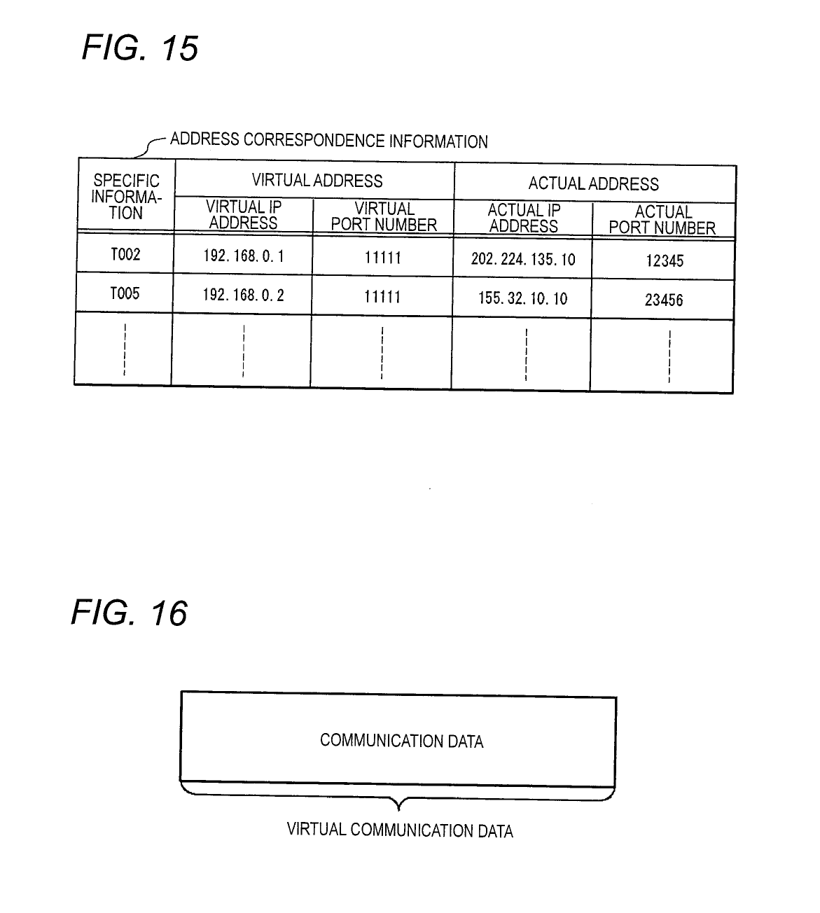

Also, the above-explained concrete example has described such a case that the virtual address contained in the address correspondence information has contained only the virtual IP address. As shown in FIG. 15, the virtual address may alternatively contain a virtual IP address and a virtual port number.

Also, the above-explained concrete example has contained such a case that the virtual communication data containing the virtual address and the communication data has been constructed. Alternatively, such a virtual communication data may be constructed which contains the communication data, but does not contain the virtual address. In this alternatively case, a brief description is made of two sets of concrete examples in which virtual communication data are constructed. Firstly, a first concrete example will be explained. The virtual communication processing unit 15 may accept both communication data and a virtual address from the information processing unit 11, and then, may directly utilize this accepted communication data as virtual communication data, as indicated in FIG. 16. Then, the virtual communication processing unit 15 may pass this virtual communication data and an actual address corresponding to the virtual address with respect to the communication processing unit 16. Next, a second concrete example will be explained. The virtual communication processing unit 15 may accept both communication data and a virtual address from the information processing unit 11, and then, similar to the description made in the above-explained concrete example, may construct such a packet that the virtual address is contained in a header thereof, and the communication data is contained in a payload thereof. The virtual communication processing unit 15 may delete the header from this packet so as to construct such a virtual communication data which contains the communication data, but does not contain the virtual address. Then, the virtual communication processing unit 15 may pass this constructed virtual communication data, and an actual address corresponding to the virtual address with respect to the communication processing unit 16. In the case where when a packet receiving process operation is carried out, a virtual address of a communication destination is passed to the information processing unit 11 under such a case that the virtual address is not contained in the virtual communication data, the virtual communication processing unit 15 may execute such a process operation that a virtual address corresponding to the actual address contained in the header of the received communication packet is acquired from the address correspondence information, and then, may pass the acquired virtual address to the information processing unit 11 as the virtual address of the communication destination.

Further, as apparent from the foregoing descriptions, such information except for the information explained in the concrete examples may be alternatively contained in the payload and the header of the packet explained in this concrete example. For instance, information such as a session ID and the like may be alternatively contained in the header of the packet.

Also, for instance, communications with employment of virtual addresses are accomplished when a communication is completed in response to an instruction issued from the information processing unit 11; when a communication is completed by the information processing unit 11; when the information processing unit 11 is accomplished under abnormal condition; when a communication is completed by the information communication apparatus 1; when the information communication apparatus 1 is completed under abnormal condition; and the like. Also, in the case where the information processing unit 11 cannot be communicated with the communication destination for a time period which is longer than, or equal to a constant time period, the information processing unit 11 may alternatively pass an instruction for instructing that the communication with employment of the virtual address is accomplished with respect to the virtual communication processing unit 15.

As previously described, in the information communication apparatus 1 according to the present embodiment mode, even in the case that the information processing unit 11 performs the communication with employment of the virtual address and the change in the actual address is detected, the virtual communication processing unit 15 continuously executes the communication data process operation, so that the information processing unit 11 can maintain the communication with the communication destination apparatus irrespective of the actual communication situation. As a result, even when the communication with employment of the actual address is temporarily cut off since the information communication apparatus 1 has entered into a tunnel, and the like, the information processing unit 11 can continuously maintain the above-described communication. As a consequence, after the communication with employment of the actual address is restarted, the information processing unit 11 can immediately restart to transmit/receive data with respect to the communication destination apparatus.

It should also be noted that the present embodiment mode has explained such a case that in the steps S206 and S210 of the flow chart shown in FIG. 3, the communication data and the virtual communication data have been discarded. Alternatively, the communication data and the like may not be discarded, but may be queued in a memory, and the like. In this alternative case, it is so assumed that after such a situation that the communication can be carried out is established, a process operation for transmitting the queued communication data and the like to the communication destination apparatus is carried out.

Further, in the present embodiment mode, the process operation in which the actual address and the virtual address of the information communication apparatus 1 are set, and the process operation in which the information communication apparatus 1 grasps the actual address and the virtual address of the communication destination apparatus are not limited only to the process operations explained in the above-descriptions, but may be executed by other methods. For example, the information communication apparatus 1 may alternatively acquire the virtual address of the communication destination apparatus by employing mutual connecting systems such as ARP (Address Resolution Protocol) and DLNA (Digital Living Network Alliance), which are executed within a tunnel suspended between the information communication apparatus 1 and the communication destination apparatus.

### Embodiment Mode 2

Referring now to drawings, a description is made of an information communication apparatus according to an embodiment mode 2 of the present invention. The information communication apparatus according to the present embodiment mode is furthermore equipped with a communication re-establishing unit for re-establishing a communication.

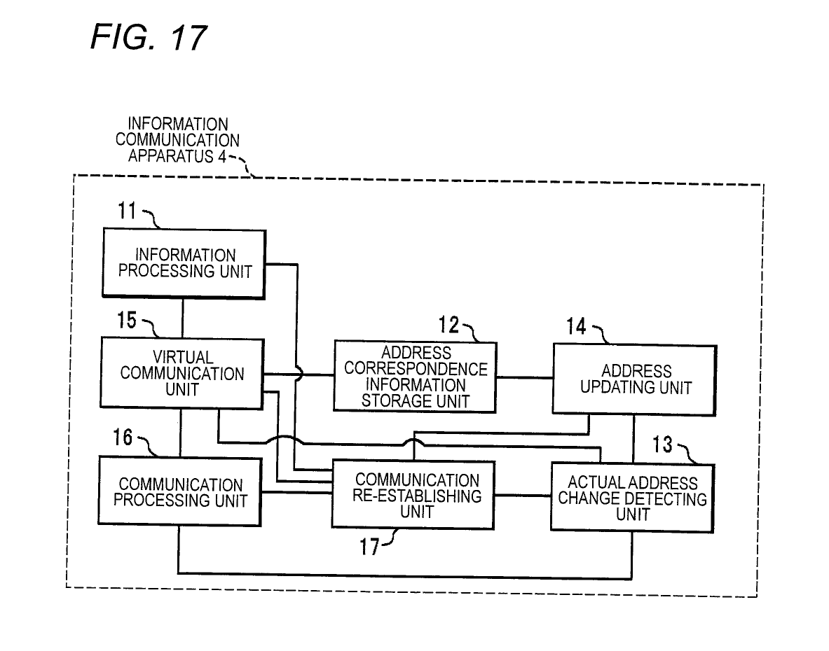

FIG. 17 is a block diagram for showing an arrangement of the information communication apparatus 4 according to the embodiment mode 2 of the present invention. In FIG. 17, the information communication apparatus 1 according to the present embodiment mode is equipped with an information processing unit 11, an address correspondence information storage unit 12, an actual address change detecting unit 13, an address updating unit 14, a virtual communication processing unit 15, a communication processing unit 16, and a communication re-establishing unit 17. It should be understood that structures and operations of the information communication apparatus 4 except for the communication re-establishing unit 17 are similar to those of the embodiment mode 1 except that the virtual communication processing unit 15 does not execute a process operation for re-establishing a communication, and therefore, descriptions thereof will be omitted.

In the case that a communication with employment of an actual address is cut off, the communication re-establishing unit 17 establishes a communication with employment of an actual address with respect to a communication destination. A situation where a communication is established implies such a situation that information transmitted from the information communication apparatus 4 is received by an apparatus of a communication destination, and information transmitted from the apparatus of the communication destination is received by the information communication apparatus 4. Alternatively, the communication re-establishing unit 17 may establish such a communication between the information communication apparatus 4 and an apparatus that is specified based upon specific information, while this specific information corresponds to such an information for specifying the apparatus of the communication destination which was communicated before the communication with employment of the actual address has been cut off. With employment of the above-described communication establishment, even in such a case that the communication established with the communication destination is cut off, the communication which was established with the communication destination apparatus before the first-mentioned communication has been cut off can be again cut off. In this case, the above-explained specific information is similar to that of the foregoing description.

The communication re-establishing unit 17 is operated as follows: That is, for instance, in the case that an actual address of a communication destination has changed, so that the communication with employment of the actual address is cut off, the communication re-establishing unit 17 interrogates a predetermined server apparatus about a new actual address of the communication destination apparatus, and accepts the interrogated new actual address, so that a communication may be established. In such a case, there is no limitation as to means for acquiring the actual address of the communication destination apparatus after having changed by the communication re-establishing unit 17. As concrete methods by which two sets of apparatuses establish a communication, for instance, a method with employment of an SIP may be employed, and also, the methods described in the respective publications (namely, publication 1 to publication 4) explained in the embodiment mode 1 may be employed. In such a case that an apparatus having an NAT function is present between the information communication apparatus 1 and the communication destination apparatus, in particular, the methods described in the respective publications (namely, publication 1 to publication 4) explained in the embodiment mode 1 become effective.

Alternatively, the communication re-establishing unit 17 may establish a communication with respect to an apparatus of a communication destination not only when the communication is cut off, but also when the communication is commenced. Otherwise, when the communication is commenced, another structural element may alternatively establish the communication with respect to the communication apparatus. The apparatus of the communication destination to which the communication is established may be realized as a terminal apparatus which is similar to the above-explained information communication apparatus 4, or may be alternatively realized as a server such as a Web server, a database server, a relay server, or the like. The communication which is established by the communication re-establishing unit 17 may be alternatively realized as a so-called “P2P communication”, namely, a communication executed between terminal apparatuses without via a server, or the like.

It should also be understood that operations of the information communication apparatus 4 are similar to those of the above-described embodiment mode 1 except that when the communication with employment of the actual address is cut off, the process operation for establishing the communication with employment of the actual address with respect to the communication destination is carried out not by the virtual communication processing unit 15, but by the communication re-establishing unit 17, and therefore, a description thereof will be omitted.

Alternatively, in such a case that the actual address change detecting unit 13 has detected a change in an actual address, the actual address change detecting unit 13 may alternatively notify such a fact to the virtual communication processing unit 15 and the communication processing unit 16. In this alternative case, as previously described also in the embodiment mode 1, such a fact that the change in the actual address has been detected is not notified to the information processing unit 11. As a consequence, it is so assumed that even when the actual address has changed, the information processing unit 11 continuously performs the communication data process operation with respect to the virtual communication processing unit 15 without grasping this actual address change.

As previously described, similar to the information communication apparatus 1 according to the embodiment mode 1, also, in the information communication apparatus 4 according to the present embodiment mode, while the information processing unit 11 performs the communication with employment of the virtual address, even when the change in the actual address is detected, the virtual communication processing unit 15 continuously performs the communication data process operation. As a result, the information processing unit 11 can maintain the communication with respect to the apparatus of the communication destination irrespective of the actual communication situation.

It should also be understood that when the change in the actual address has been detected, the embodiment modes 1 and 2 have explained such a case that the process operation for establishing the communication has been carried out (refer to flow charts shown in FIG. 2 and FIG. 4). However, even in such a case that the change in the actual address is detected, if the communication can be continuously carried out, then the process operation for establishing the communication may not be performed. For example, as previously explained in the embodiment mode 1, in such a case that the detection as to the change in the actual address is carried out by “(2) Detection based upon reception of such a fact from an apparatus of a communication destination that an actual address has changed”, or “(3) Detection based upon a change in a source address of a packet transmitted from an apparatus of a communication destination”, even when the change in the actual address is detected, there are some possibilities that the information communication apparatuses 1 and 3 may continuously perform the communications with the apparatus of the communication destination. In these cases, even when the change in the actual address is detected, the process operation for establishing the communication by either the virtual communication processing unit 15 or the communication re-establishing unit 17 may not be alternatively carried out. In such a case, when the change in the actual address has been detected, if the communication with the communication destination apparatus has been cut off, then the process operation for establishing the communication may be carried out, whereas if the communication with the communication destination apparatus has not been cut off, then the process operation for establishing the communication may not be carried out. Even in such a case that the process operation for establishing the communication is not carried out, if the actual address of the communication destination has changed, then it is so assumed that the address correspondence information is updated. In other words, in the flow chart of FIG. 4, first of all, a judgment is made whether or not the communication with the communication destination apparatus has been cut off. If the above-described communication has been cut off, then the process operation may be advanced to the step S301, whereas if this communication has not been cut off, then the process operation may be advanced to the step S303.

Also, in the flow chart of FIG. 3 of the embodiment modes 1 and 2, even in such a case that the communication by the communication processing unit 16 cannot be carried out, the virtual communication processing unit 15 may discard the communication data. Further, even in such a case that there is no actual address corresponding to the virtual address, the communication processing unit 16 may alternatively discard the virtual communication data.

Also, in the embodiment modes 1 and 2, in such a case that a detection is made of such a fact that the actual address of the information communication apparatus 1 has been deleted, either the virtual communication processing unit 15 or the communication processing unit 16 may alternatively perform such a process operation for closing a port corresponding to this actual address. It should also be noted that even when the port corresponding to the actual address is closed, a port corresponding to the virtual address has not be closed to be left.

Also, in the above-described embodiment modes 1 and 2, either the virtual communication processing unit 15 or the communication processing unit 16 may alternatively have the function of the actual address change detecting unit 13. In this alternative case, the above-described alternative structure may be equal to such a structure that either the virtual communication processing unit 15 or the communication processing unit 16 contains the actual address change detecting unit 13.

Furthermore, in the embodiment modes 1 and 2, the virtual communication processing unit 15 may alternatively have the function of the address updating unit 14. In this alternative case, the above-explained alternative structure may be equal to such a structure that the virtual communication processing unit 15 contains the address updating unit 14.

Also, the above-explained embodiment modes 1 and 2, either the respective process operations or the respective functions may be realized by being processed in a concentration manner by employing either a single apparatus or a single system, otherwise, may be alternatively realized by being processed in a distributed processing manner by employing either a plurality of apparatuses or a plurality of systems.

Further, in the respective embodiment modes 1 and 2, the respective structural elements may be arranged by employing exclusively used hardware. Otherwise, such structural elements that may be realized by software may be alternatively realized by executing a program. For example, since a software/program recorded on a recording medium such as a hard disk, a semiconductor memory, and the like may be read out by a program executing unit (CPU etc.) so as to be executed by this program executing unit, the respective structural elements may be alternatively realized. It should be understood that the software capable of realizing the information communication apparatuses in the above-explained embodiment modes is the below-mentioned program. That is, this program causes a computer to execute: an information processing step for issuing a transmission request related to communication data by employing a virtual address; an actual address change detecting step for detecting a change in an actual address used in a transmission; an address updating step for updating address correspondence information in response to the change in the actual address in such a case that the actual address change detecting step has detected the change in the actual address, while the address correspondence information has been stored in an address correspondence information storage unit for storing thereinto one, or more pieces of address correspondence information which corresponds to such an information having the virtual address used in the transmission and the actual address used in the transmission in correspondence with each other; a virtual communication processing step for constructing virtual communication data by employing the communication data based upon the transmission request issued in the information processing step, for acquiring an actual address from the address correspondence information, which corresponds to the virtual address employed in the transmission request issued in the information processing step, and for performing a communication data process operation related to the virtual communication data with employment of the actual address; and also, a communication processing step for accepting both the virtual communication data constructed in the virtual communication processing step and the actual address acquired in the virtual communication processing step, and for performing a communication process operation with employment of the accepted virtual communication data and the accepted actual address; in which even in such a case that the actual address change detecting step has detected the change in the actual address, the virtual communication processing step continuously performs the communication data process operation.

It should also be understood that in the above-explained program, at least such process operations which are executed only in hardware are not involved in the communication processing steps, for instance, at least such process operations which are executed in a modem, an interface card, and the like in the communication process steps are not involved in the above-explained program.

Alternatively, this program may be executed by being downloaded for a server and the like. Also, the above-explained program may be alternatively executed in such a manner that a program is read out which has been recorded in a predetermined recording medium (for example, optical disk such as CD-ROM, magnetic disk, semiconductor memory etc.).

Also, the computer that executes the program may be realized by a single computer or a plurality of computers. In other words, the program may be alternatively executed by performing a concentrated processing manner, or a distributed processing manner.

It should also be understood that the present invention is not limited only to the above-described embodiment modes, but may be modified in various manners, and thus, as apparently from the foregoing descriptions, these modified embodiment modes may be covered within the technical scope of the present invention.

Although the present invention has been described in detail, or with reference to the specific embodiment modes, it is obvious for ordinarily skilled engineers to concave such a fact that the present invention may be modified and changed in various manners without departing from the technical scope and spirit of the present invention.

The present patent application has been filed on the basis of claiming Japanese Patent Application (JP-A-2006-276211) filed on Oct. 10, 2006, the contents of which have been incorporated herewith as references.

### INDUSTRIAL APPLICABILITY

The present invention has been suitably applied to such an information communication apparatus, and the like, which are communicated with other apparatuses, while the information communication apparatus and the like, according to the present invention, can maintain the communication with employment of the virtual address even when the actual address has changed.

1-12. (canceled)

13. An information communication apparatus comprising:
an information processing unit, issuing a transmission request related to communication data by employing a virtual address;
an address correspondence information storage unit, storing thereinto one or more pieces of address correspondence information which corresponds to an information having the virtual address used in the transmission and an actual address used in the transmission in correspondence with each other;
an actual address change detecting unit, detecting a change in the actual address used in the transmission;
an address updating unit, updating the address correspondence information in response to the change in the actual address, that has been stored in the address correspondence information storage unit in such that the actual address change detecting unit has detected the change in the actual address;
a virtual communication processing unit, constructing virtual communication data by employing the communication data accepted from the information processing unit based upon the transmission request issued from the information processing unit, acquiring an actual address from the address correspondence information, that corresponds to the virtual address accepted from the information processing unit, and performing a communication data process operation related to the virtual communication data by employing the acquired actual address; and
a communication processing unit, performing a communication process operation by accepting both the virtual communication data and the actual address from the virtual communication processing unit with employment of the accepted virtual communication data and the accepted actual address;
wherein even in a case that the actual address change detecting unit has detected the change in the actual address, the virtual communication processing unit continuously performs the communication data process operation.

14. The information communication apparatus as claimed in claim 13, wherein the communication processing unit has held an actual address of the information communication apparatus; and
the actual address change detecting unit detects a change in the actual address of the information communication apparatus.

15. The information communication apparatus as claimed in claim 13, wherein the actual address change detecting unit detects a change in an actual address held by an apparatus of a communication destination.

16. The information communication apparatus as claimed in claim 15 wherein the actual address change detecting unit detects a change in an actual address defined in correspondence with specific information which corresponds to such an information for specifying the apparatus of the communication destination.

17. The information communication apparatus as claimed in claim 13, wherein the virtual communication processing unit constructs virtual communication data which contains the virtual address and the communication data, which are accepted from the information processing unit.

18. The information communication apparatus as claimed in claim 13, wherein the virtual communication processing unit constructs virtual communication data which contains the virtual address, but does not contain the communication data, which are accepted from the information processing unit.

19. The information communication apparatus as claimed in claim 13, wherein the information communication apparatus is further comprised of:
a communication re-establishing unit for establishing a communication with employment of an actual address with respect to the communication destination in the case that the communication with employment of the actual address has been cut off

20. The information communication apparatus as claimed in claim 19 wherein the communication re-establishing unit establishes a communication with an apparatus specified by specific information which corresponds to such an information for specifying the apparatus of the communication destination which had been communicated therewith before the communication with employment of the actual address has been cut off.

21. The information communication apparatus as claimed claim 13 wherein:
in a case that the actual address change detecting unit has detected a change in an actual address, the actual address change detecting unit notifies such a fact that the change in the actual address has been detected with respect to the communication processing unit.

22. The information communication apparatus as claimed in claim 13 wherein in a case that the actual address change detecting unit has detected a change in an actual address, the actual address change detecting unit notifies such a fact that the change in the actual address has been detected with respect to the virtual communication processing unit.

23. An information communication method, comprising:
an information processing step for issuing a transmission request related to communication data by employing a virtual address;
an actual address change detecting step for detecting a change in an actual address used in a transmission;
an address updating step for updating address correspondence information in response to the change in the actual address in such a case that the actual address change detecting step has detected the change in the actual address, while the address correspondence information has been stored in an address correspondence information storage unit for storing thereinto one or more pieces of address correspondence information which corresponds to such an information having the virtual address used in the transmission and the actual address used in the transmission in correspondence with each other;
a virtual communication processing step for constructing virtual communication data by employing the communication data based upon the transmission request issued in the information processing step, for acquiring an actual address from the address correspondence information, which corresponds to the virtual address employed in the transmission request issued in the information processing step, and for performing a communication data process operation related to the virtual communication data with employment of the actual address; and
a communication processing step for accepting both the virtual communication data constructed in the virtual communication processing step and the actual address acquired in the virtual communication processing step, and for performing a communication process operation with employment of the accepted virtual communication data and the accepted actual address; wherein:
even in a case that the actual address change detecting step has detected the change in the actual address, the virtual communication processing step continuously performs the communication data process operation.

24. A computer program product embodied on a computer readable medium which, when executed by a computer, cause the computer to execute:
an information processing step for issuing a transmission request related to communication data by employing a virtual address;
an actual address change detecting step for detecting a change in an actual address used in a transmission;
an address updating step for updating address correspondence information in response to the change in the actual address in such a case that the actual address change detecting step has detected the change in the actual address, while the address correspondence information has been stored in an address correspondence information storage unit for storing thereinto one or more pieces of address correspondence information which corresponds to such an information having the virtual address used in the transmission and the actual address used in the transmission in correspondence with each other;
a virtual communication processing step for constructing virtual communication data by employing the communication data based upon the transmission request issued in the information processing step, for acquiring an actual address from the address correspondence information, which corresponds to the virtual address employed in the transmission request issued in the information processing step, and for performing a communication data process operation related to the virtual communication data with employment of the actual address; and
a communication processing step for accepting both the virtual communication data constructed in the virtual communication processing step and the actual address acquired in the virtual communication processing step, and for performing a communication process operation with employment of the accepted virtual communication data and the accepted actual address; wherein:
even in a case that the actual address change detecting step has detected the change in the actual address, the virtual communication processing step continuously performs the communication data process operation.
